(19) United States
(12) Patent Application Publication
(10) Pub. No.: US 2005/0117802 A1
(43) Pub. Date: Jun. 2, 2005

(54) Image processing method, apparatus, and program

(75) Inventors: Makoto Yonaha, Kanagawa-ken (JP); Tao Chen, Kawasaki-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/936,813

(22) Filed: Sep. 9, 2004

(30) Foreign Application Priority Data
Sep. 9, 2003 (JP) 358507/2003

(51) Int. Cl. G06K 9/34; G06K 9/46; G06K 9/36

(52) U.S. Cl. 382/173; 382/190; 382/286

(57) ABSTRACT

Values L1a, L1b, and L1c are obtained by performing operations according to the following equations, using the distance D1 between both pupils in a facial photograph image. A facial frame is determined by using the values L1a, L1b, and L1c as the lateral width of the facial frame with its middle in the lateral direction at the middle position between both eyes, the distance from the middle position to the upper side of the facial frame, and the distance from the middle position to the lower side of the facial frame, respectively. A trimming area is set by using the facial frame.
L1a=D×3.250
L1b=D×1.905
L1c=D×2.170

### BACKGROUND OF THE INVENTION

1. Field of the Invention

The present invention relates to an image processing method and an image processing apparatus for setting a trimming area in a facial photograph image, a program for causing a computer to execute the image processing method, a digital camera, and a photography box apparatus.

2. Description of the Related Art

When people apply for their passports or driver's licenses, prepare their resumes, or the like, they are often required to submit photographs (hereinafter called identification photographs) of their faces in a predetermined output format for each occasion. Therefore, conventionally, automatic identification photograph production apparatuses have been used. In the automatic identification photograph production apparatus, a photography room for taking a photograph of a user is provided. A photograph of the user, who sits on a chair in the photography room, is taken and an identification photograph sheet is automatically produced, on which a facial photograph image of the user for an identification photograph is recorded. Since the size of the automatic identification photograph production apparatus as described above is large, the automatic identification photograph production apparatus may be installed only at limited places. Therefore, the users need to search for a place, where the automatic identification photograph production apparatus is installed, and go to the place to obtain their identification photographs. This is inconvenient for the users.

To solve this problem, a method for forming an identification photograph image has been proposed in Japanese Unexamined Patent Publication No. 11(1999)-341272, for example. In this method, while a facial photograph image (an image including a face), which will be used to produce an identification photograph, is displayed on a display device such as a monitor, a user indicates the position of the top of a head and the position of the tip of a chin in the displayed facial photograph image. Then, a computer calculates an enlargement or reduction ratio of the face and the position of the face, based on the two positions, which are indicated by the user, and an output format of the identification photograph, and enlarges or reduces the image. The computer also trims the enlarged or reduced facial photograph image so that the face in the enlarged or reduced image is positioned at a predetermined position in the identification photograph, and the identification photograph image is generated. According to this method, the users may request DPE shops or the like to produce their identification photographs. There are more DPE shops than the automatic identification photograph production apparatuses. The users may also bring their photograph films or recording media, on which their favorite photographs are recorded, to the DPE shops or the like to produce their identification photographs from their favorite photographs, which they already have.

However, in the technique as described above, an operator is required to perform complex operations to indicate each of the position of the top of the head and the position of the tip of the chin in a displayed facial photograph image. Therefore, especially when the operator needs to produce identification photographs of many users, the work load on the operator is heavy. Further, especially if the area of a facial region in the displayed facial photograph image is small, or the resolution of the facial photograph image is coarse, it is difficult for the operator to indicate the position of the top of the head and the position of the tip of the chin quickly and accurately. Therefore, there is a problem that appropriate identification photographs cannot be produced quickly.

Further, a method for setting a trimming area has been proposed in U.S. Patent Laid-Open No. 20020085771. In this method, the position of the top of a head and the positions of both eyes are detected in a facial photograph image. The position of the tip of a chin is estimated from the detected position of the top of the head and the detected positions of both eyes, and a trimming area is set in the facial photograph image. According to this method, the operator is not required to indicate the position of the top of the head and the position of the tip of the chin to produce an identification photograph from the facial photograph image.

However, in the method disclosed in U.S. Patent Laid-Open No, 20020085771, besides detection of the eyes, detection of the top of the head is required. Therefore, processing is complex.

Further, although the top of the head is positioned in the part of a face above the eyes, the top of the head is detected from the whole facial photograph image. Therefore, a long time is required for processing. Further, there is a possibility that the top of the head is not detected accurately depending on the color of person's clothes in the facial photograph image. Consequently, there is a problem that an appropriate trimming area cannot be set.

### SUMMARY OF THE INVENTION

In view of the foregoing circumstances, it is an object of the present invention to provide an image processing method and an image processing apparatus for setting a trimming area in a facial photograph image accurately and quickly and a program for causing a computer to execute the image processing method.

A first image processing method according to the present invention is an image processing method comprising the steps of:
obtaining a facial frame by using each of values L1a, L1b and L1c, which are obtained by performing operations according to equations (1) by using the distance D between both eyes in a facial photograph image and coefficients U1a, U1b and U1c, as the lateral width of the facial frame with its middle in the lateral direction at the middle position Gm between both eyes in the facial photograph image, the distance from the middle position Gm to the upper side of the facial frame, and the distance from the middle position Gm to the lower side of the facial frame, respectively; and
setting a trimming area in the facial photograph image based on the position and the size of the facial frame so that the trimming area satisfies a predetermined output format, wherein the coefficients U1a, U1b and U1c are obtained by performing processing on a multiplicity of sample facial photograph images to obtain absolute values of differences between each value of Lt1a, Lt1b and Lt1c, which are obtained by performing operations according to equations (2) by using the distance Ds between both eyes in each of the sample facial photograph images and predetermined test coefficients Ut1a, Ut1b and Ut1c, the lateral width of a face, the distance from the middle position between both eyes to the upper end of the face, and the distance from the middle position between both eyes to the lower end of the face, respectively, in each of the sample facial photograph images and optimizing the test coefficients so that the sum of the absolute values of the differences, which are obtained for each of the sample facial photograph images, is minimized.
   L1a=D×U1a
   L1b=D×U1b (1)
   L1c=D×U1c
   Lt1a=Ds×Ut1a
   Lt1b=Ds×Ut1b (2)
   Lt1c=Ds×Ut1c

Here, the “lateral width of the face” refers to the maximum width of the face in the lateral direction (the alignment direction of both eyes). The lateral width of the face may be the distance from a left ear to a right ear, for example. The “upper end of the face” refers to the highest position in the face in the longitudinal direction, which is perpendicular to the lateral direction of the face. The upper end of the face may be the top of the head, for example. The “lower end of the face” refers to the lowest position in the face in the longitudinal direction of the face. The lower end of the face may be the tip of the chin, for example.

Although each human face has a different size from each other, the size of each human face (a lateral width and a longitudinal width) corresponds to the distance between both eyes in most cases. Further, the distance from the eyes to the top of the head and the distance from the eyes to the tip of the chin also correspond to the distance between both eyes. These features are utilized in the first image processing method according to the present invention. Coefficients U1a, U1b and U1c are statistically obtained by using a multiplicity of sample facial photograph images. The coefficients U1a, U1b and U1c represent the relationships between the distance between both eyes and the lateral width of a face, the distance from the eyes to the upper end of the face, and the distance from the eyes to the lower end of the face, respectively. Then, a facial frame is obtained based on the positions of the eyes and the distance between both eyes in the facial photograph image, and a trimming area is set.

Further, the position of the eye is not limited to the center of the eye in the present invention. The position of the eye may be the position of a pupil, the position of the outer corner of the eye, or the like.

It is preferable to use the distance d1 between the pupils of both eyes as the distance between both eyes as illustrated in FIG. 30. However, the distance d2 between the inner corners of both eyes, the distance d3 between the centers of both eyes, the distance d4 between the outer corner of an eye and the center of the other eye, and the distance d5 between the outer corners of both eyes may also be used as the distance between both eyes as illustrated in FIG. 30. Further, the distance between the pupil of an eye and the center of the other eye, the distance between the pupil of an eye and the outer corner of the other eye, the distance between the outer corner of an eye and the inner corner of the other eye, or the like, which are not illustrated, may also be used as the distance between both eyes.

A second image processing method according to the present invention is an image processing method comprising the steps of:
detecting the position of the top of a head from the part above the positions of eyes in a facial photograph image and calculating the perpendicular distance H from the eyes to the top of the head;
obtaining a facial frame by using each of values L2a and L2c, which are obtained by performing operations according to equations (3) by using the distance D between both eyes in the facial photograph image, the perpendicular distance H and coefficients U2a and U2c, as the lateral width of the facial frame with its middle in the lateral direction at the middle position Gm between both eyes in the facial photograph image and the distance from the middle position Gm to the lower side of the facial frame, respectively, and using the perpendicular distance H as the distance from the middle position Gm to the upper side of the facial frame; and
setting a trimming area in the facial photograph image based on the position and the size of the facial frame so that the trimming area satisfies a predetermined output format, wherein the coefficients U2a and U2c are obtained by performing processing on a multiplicity of sample facial photograph images to obtain absolute values of differences between each value of Lt2a and Lt2c, which are obtained by performing operations according to equations (4) by using the perpendicular distance Hs from eyes to the top of a head and the distance Ds between both eyes in each of the sample facial photograph images and predetermined test coefficients Ut2a and Ut2c, and the lateral width of a face and the distance from the middle position between both eyes to the lower end of the face, respectively, in each of the sample facial photograph images and optimizing the test coefficients so that the sum of the absolute values of the differences, which are obtained for each of the sample facial photograph images, is minimized.
   L2a=D×U2a
   L2c=H×U2c (3)
   Lt2a=Ds×Ut2a
   Lt2b=Hs×Ut2c (4)

A third image processing method according to the present invention is an image processing method comprising the steps of:
detecting the position of the top of a head from the part above the positions of eyes in a facial photograph image and calculating the perpendicular distance H from the eyes to the top of the head;
obtaining a facial frame by using each of values L3a and L3c, which are obtained by performing operations according to equations (5) by using the distance D between both eyes in the facial photograph image, the perpendicular distance H and coefficients U3a, U3b and U3c, as the lateral width of the facial frame with its middle in the lateral direction at the middle position Gm between both eyes in the facial photograph image and the distance from the middle position Gm to the lower side of the facial frame, respectively, and using the perpendicular distance H as the distance from the middle position Gm to the upper side of the facial frame; and
setting a trimming area in the facial photograph image based on the position and the size of the facial frame so that the trimming area satisfies a predetermined output format, wherein the coefficients U3a, U3b and U3c are obtained by performing processing on a multiplicity of sample facial photograph images to obtain absolute values of differences between each value of Lt3a and Lt3c, which are obtained by performing operations according to equations (6) by using the perpendicular distance Hs from eyes to the top of a head and the distance Ds between both eyes in each of the sample facial photograph images and predetermined test coefficients Ut3a, Ut3b and Ut3c, and the lateral width of a face and the distance from the middle position between both eyes to the lower end of the face, respectively, in each of the sample facial photograph images and optimizing the test coefficients so that the sum of the absolute values of the differences, which are obtained for each of the sample facial photograph images, is minimized.
   L3a=D×U3a
   L3c=D×U3b+H×U3c (5)
   Lt3a=Ds×Ut3a
   Lt3b=Ds×Ut3b+Hs×Ut3c (6)

A fourth image processing method according to the present invention is an image processing method comprising the step of:
setting a trimming area by using each of values L4a, L4b and L4c, which are obtained by performing operations according to equations (7) by using the distance D between both eyes in a facial photograph image and coefficients U4a, U4b and U4c, as the lateral width of the trimming area with its middle in the lateral direction at the middle position Gm between both eyes in the facial photograph image, the distance from the middle position Gm to the upper side of the trimming area, and the distance from the middle position Gm to the lower side of the trimming area, respectively, wherein the coefficients U4a, U4b and U4c are obtained by performing processing on a multiplicity of sample facial photograph images to obtain absolute values of differences between each value of Lt4a, Lt4b and Lt4c, which are obtained by performing operations according to equations (8) by using the distance Ds between both eyes in each of the sample facial photograph images and predetermined test coefficients Ut4a, Ut4b and Ut4c, and the lateral width of a predetermined trimming area with its middle in the lateral direction at the middle position between both eyes, the distance from the middle position between both eyes to the upper side of the predetermined trimming area and the distance from the middle position between both eyes to the lower side of the predetermined trimming area, respectively, in each of the sample facial photograph images and optimizing the test coefficients so that the sum of the absolute values of the differences, which are obtained for each of the sample facial photograph images, is minimized.
   L4a=D×U4a
   L4b=D×U4b (7)
   L4c=D×U4c
   Lt4a=Ds×Ut4a
   Lt4b=Ds×Ut4b (8)
   Lt4c=Ds×Ut4c

A fifth image processing method according to the present invention is an image processing method comprising the steps of:
detecting the position of the top of a head from the part above the positions of eyes in a facial photograph image and calculating the perpendicular distance H from the eyes to the top of the head; and
setting a trimming area by using each of values L5a, L5b and L5c, which are obtained by performing operations according to equations (9) by using the distance D between both eyes and the perpendicular distance H in the facial photograph image and coefficients U5a, U5b and U5c, as the lateral width of the trimming area with its middle in the lateral direction at the middle position Gm between both eyes in the facial photograph image, the distance from the middle position Gm to the upper side of the trimming area, and the distance from the middle position Gm to the lower side of the trimming area, respectively, wherein the coefficients U5a, U5b and U5c are obtained by performing processing on a multiplicity of sample facial photograph images to obtain absolute values of differences between each value of Lt5a, Lt5b and Lt5c, which are obtained by performing operations according to equations (10) by using the perpendicular distance Hs from eyes to the top of a head and the distance Ds between both eyes in each of the sample facial photograph images and predetermined test coefficients Ut5a, Ut5b and Ut5c, and the lateral width of a predetermined trimming area with its middle in the lateral direction at the middle position of both eyes, the distance from the middle position between both eyes to the upper side of the trimming area and the distance from the middle position between both eyes to the lower side of the trimming area, respectively, in each of the sample facial photograph images and optimizing the test coefficients so that the sum of the absolute values of the differences, which are obtained for each of the sample facial photograph images, is minimized.
   L5a=D×U5a
   L5b=H×U5b (9)
   L5c=H×U5c
   Lt5a=Ds×Ut5a
   Lt5b=Hs×Ut5b (10)
   Lt5c=Hs×Ut5c

A sixth image processing method according to the present invention is an image processing method comprising the steps of:
detecting the position of the top of a head from the part above the positions of eyes in a facial photograph image and calculating the perpendicular distance H from the eyes to the top of the head; and
setting a trimming area by using each of values L6a, L6b and L6c, which are obtained by performing operations according to equations (11) by using the distance D between both eyes and the perpendicular distance H in the facial photograph image and coefficients U6a, U6b1, U6c1, U6b2 and U6c2, as the lateral width of the trimming area with its middle in the lateral direction at the middle position Gm between both eyes in the facial photograph image, the distance from the middle position Gm to the upper side of the trimming area, and the distance from the middle position Gm to the lower side of the trimming area, respectively, wherein the coefficients U6a, U6b1, U6c1, U6b2 and U6c2 are obtained by performing processing on a multiplicity of sample facial photograph images to obtain absolute values of differences between each value of Lt6a, Lt6b and Lt6c, which are obtained by performing operations according to equations (12) by using the perpendicular distance Hs from eyes to the top of a head and the distance Ds between both eyes in each of the sample facial photograph images and predetermined test coefficients Ut6a, Ut6b1, Ut6c1, Ut6b2 and Ut6c2, and the lateral width of a predetermined trimming area with its middle in the lateral direction at the middle position of both eyes, the distance from the middle position between both eyes to the upper side of the trimming area and the distance from the middle position between both eyes to the lower side of the trimming area, respectively, in each of the sample facial photograph images and optimizing the test coefficients so that the sum of the absolute values of the differences, which are obtained for each of the sample facial photograph images, is minimized.
   L6a=D×U6a
   L6b=D×U6b1+H×U6c1 (11)
   L6c=D×U6b2+H×U6c2
   Lt6a=Ds×Ut6a
   Lt6b=Ds×Ut6b1+Hs×Ut6c1 (12)
   Lt6c=Ds×Ut6b2+Hs×Ut6c2

Specifically, in the first, second and third image processing methods according to the present invention, a facial frame is obtained and a trimming area, which satisfies a predetermined output format, is set based on the position and the size of the facial frame. In contrast, in the fourth, fifth and sixth image processing methods according to the present invention, a trimming frame is directly set based on the positions of the eyes and the distance between both eyes or based on the positions of the eyes, the distance between both eyes and the perpendicular distance H from the eyes to the top of the head.

A first image processing apparatus according to the present invention is an image processing apparatus comprising:
a facial frame obtainment means for obtaining a facial frame by using each of values L1a, L1b and L1c, which are obtained by performing operations according to equations (13) by using the distance D between both eyes in a facial photograph image and coefficients U1a, U1b and U1c, as the lateral width of the facial frame with its middle in the lateral direction at the middle position Gm between both eyes in the facial photograph image, the distance from the middle position Gm to the upper side of the facial frame, and the distance from the middle position Gm to the lower side of the facial frame, respectively; and
a trimming area setting means for setting a trimming area in the facial photograph image based on the position and the size of the facial frame so that the trimming area satisfies a predetermined output format, wherein the coefficients U1a, U1b and U1c are obtained by performing processing on a multiplicity of sample facial photograph images to obtain absolute values of differences between each value of Lt1a, Lt1b and Lt1c, which are obtained by performing operations according to equations (14) by using the distance Ds between both eyes in each of the sample facial photograph images and predetermined test coefficients Ut1a, Ut1b and Ut1c, and the lateral width of a face, the distance from the middle position between both eyes to the upper end of the face, and the distance from the middle position between both eyes to the lower end of the face, respectively, in each of the sample facial photograph images and optimizing the test coefficients so that the sum of the absolute values of the differences, which are obtained for each of the sample facial photograph images, is minimized.
   L1a=D×U1a
   L1b=D×U1b (13)
   L1c=D×U1c
   Lt1a=Ds×Ut1a
   Lt1b=Ds×Ut1b (14)
   Lt1c=Ds×Ut1c

Here, the distance between the pupils of both eyes may be used as the distance between both eyes. In this case, it is preferable that each value of the coefficients U1a, U1b and U1c is within the range of 3.250×(1±0.05), 1.905×(1±0.05) or 2.170×(1±0.05), respectively.

A second image processing apparatus according to the present invention is an image processing apparatus comprising:
a top-of-head detection means for detecting the position of the top of a head from the part above the positions of eyes in a facial photograph image and calculating the perpendicular distance H from the eyes to the top of the head;
a facial frame obtainment means for obtaining a facial frame by using each of values L2a and L2c, which are obtained by performing operations according to equations (15) by using the distance D between both eyes in the facial photograph image, the perpendicular distance H and coefficients U2a and U2c, as the lateral width of the facial frame with its middle in the lateral direction at the middle position Gm between both eyes in the facial photograph image and the distance from the middle position Gm to the lower side of the facial frame, respectively, and using the perpendicular distance H as the distance from the middle position Gm to the upper side of the facial frame; and
a trimming area setting means for setting a trimming area in the facial photograph image based on the position and the size of the facial frame so that the trimming area satisfies a predetermined output format, wherein the coefficients U2a and U2c are obtained by performing processing on a multiplicity of sample facial photograph images to obtain absolute values of differences between each value of Lt2a and Lt2c, which are obtained by performing operations according to equations (16) by using the perpendicular distance Hs from eyes to the top of a head and the distance Ds between both eyes in each of the sample facial photograph images and predetermined test coefficients Ut2a and Ut2c, and the lateral width of a face and the distance from the middle position between both eyes to the lower end of the face, respectively, in each of the sample facial photograph images and optimizing the test coefficients so that the sum of the absolute values of the differences, which are obtained for each of the sample facial photograph images, is minimized.
   L2a=D×U2a
   L2c=H×U2c (15)
   Lt2a=Ds×Ut2a
   Lt2b=Hs×Ut2c (16)

Here, the distance between the pupils of both eyes may be used as the distance between both eyes. In this case, it is preferable that each value of the coefficients U2a and U2c is within the range of 3.250×(1±0.05) or 0.900×(1±0.05), respectively.

A third image processing apparatus according to the present invention is an image processing apparatus comprising:
a top-of-head detection means for detecting the position of the top of a head from the part above the positions of eyes in a facial photograph image and calculating the perpendicular distance H from the eyes to the top of the head;
a facial frame obtainment means for obtaining a facial frame by using each of values L3a and L3c, which are obtained by performing operations according to equations (17) by using the distance D between both eyes in the facial photograph image, the perpendicular distance H and coefficients U3a, U3b and U3c, as the lateral width of the facial frame with its middle in the lateral direction at the middle position Gm between both eyes in the facial photograph image and the distance from the middle position Gm to the lower side of the facial frame, respectively, and using the perpendicular distance H as the distance from the middle position Gm to the upper side of the facial frame; and
a trimming area setting means for setting a trimming area in the facial photograph image based on the position and the size of the facial frame so that the trimming area satisfies a predetermined output format, wherein the coefficients U3a, U3b and U3c are obtained by performing processing on a multiplicity of sample facial photograph images to obtain absolute values of differences between each value of Lt3a and Lt3c, which are obtained by performing operations according to equations (18) by using the perpendicular distance Hs from eyes to the top of a head and the distance Ds between both eyes in each of the sample facial photograph images and predetermined test coefficients Ut3a, Ut3b and Ut3c, and the lateral width of a face and the distance from the middle position between both eyes to the lower end of the face, respectively, in each of the sample facial photograph images and optimizing the test coefficients so that the sum of the absolute values of the differences, which are obtained for each of the sample facial photograph images, is minimized.
   L3a=D×U3a
   L3c=D×U3b+H×U3c (17)
   Lt3a=Ds×Ut3a
   Lt3b=Ds×Ut3b+Hs×Ut3c (18)

Here, the distance between the pupils of both eyes may be used as the distance between both eyes. In this case, it is preferable that each value of the coefficients U3a, U3b and U3c is within the range of 3.250×(1±0.05), 1.525×(1±0.05) or 0.187×(1±0.05), respectively.

A fourth image processing apparatus according to the present invention is an image processing apparatus comprising:
a trimming area setting means for setting a trimming area by using each of values L4a, L4b and L4c, which are obtained by performing operations according to equations (19) by using the distance D between both eyes in a facial photograph image and coefficients U4a, U4b and U4c, as the lateral width of the trimming area with its middle in the lateral direction at the middle position Gm between both eyes in the facial photograph image, the distance from the middle position Gm to the upper side of the trimming area, and the distance from the middle position Gm to the lower side of the trimming area, respectively, wherein the coefficients U4a, U4b and U4c are obtained by performing processing on a multiplicity of sample facial photograph images to obtain absolute values of differences between each value of Lt4a, Lt4b and Lt4c, which are obtained by performing operations according to equations (20) by using the distance Ds between both eyes in each of the sample facial photograph images and predetermined test coefficients Ut4a, Ut4b and Ut4c, and the lateral width of a predetermined trimming area with its middle in the lateral direction at the middle position between both eyes, the distance from the middle position between both eyes to the upper side of the predetermined trimming area and the distance from the middle position between both eyes to the lower side of the predetermined trimming area, respectively, in each of the sample facial photograph images and optimizing the test coefficients so that the sum of the absolute values of the differences, which are obtained for each of the sample facial photograph images, is minimized.
   L4a=D×U4a
   L4b=D×U4b (19)
   L4c=D×U4c
   Lt4a=Ds×Ut4a
   Lt4b=Ds×Ut4b (20)
   Lt4c=Ds×Ut4c

Here, the distance between the pupils of both eyes may be used as the distance between both eyes. In this case, it is preferable that each value of the coefficients U4a, U4b and U4c is within the range of (5.04×range coefficient), (3.01×range coefficient) or (3.47×range coefficient), respectively. The range coefficient may be (1±0.4).

Here, it is preferable that the range coefficient is (1±0.25).

It is more preferable that the range coefficient is (1±0.10).

It is still more preferable that the range coefficient is (1±0.05).

Specifically, the fourth image processing apparatus according to the present invention corresponds to the fourth image processing method according to the present invention. The fourth image processing apparatus according to the present invention directly sets a trimming area based on the positions of the eyes and the distance between both eyes in the facial photograph image by using the coefficients U4a, U4b and U4c, which have been statistically obtained.

Here, the coefficients, which were obtained by the inventors of the present invention by using a multiplicity of sample facial photograph images (several thousand pieces), are 5.04, 3.01, and 3.47, respectively (hereinafter called U0 for the convenience of explanation). It is most preferable to set the trimming area by using these coefficients U0. However, there is a possibility that the coefficients vary depending on the number of the sample facial photograph images, which are used for obtaining the coefficients. Further, the strictness of an output format differs depending on the usage of the photograph. Therefore, each of the coefficients may have a range.

If values within the range of “coefficient U0×(1±0.05)” are used as the coefficients U4a, U4b and U4c, the passing rate of identification photographs, which are obtained by trimming the facial photograph images based on the set trimming areas, is high even if the output format is strict (for example, in the case of obtaining passport photographs). The inventors of the present invention actually conducted tests, and the passing rate was 90% or higher in the case of obtaining passport photographs.

Further, in the case of obtaining identification photographs for photograph identification cards, licenses, or the like, the output formats of the identification photographs are not as strict as the format of the passport photographs. Therefore, values within the range of “coefficient U0×(1±0.10)” may be used as the coefficients U4a, U4b and U4c.

Further, in the case of trimming a facial photograph image, which is obtained with a camera attached to a cellular phone, to leave a facial region, or in the case of trimming a facial photograph image to leave a facial region for the purposes other than the identification photographs, such as “Purikura”, the output format may be even less strict. Therefore, values within the range of “coefficient U0×(1±0.25)” may be used as the coefficients U4a, U4b and U4c.

Further, there are also output formats, which are substantially the same as the format of “at least including a face”. In these cases, the range of the coefficients may be further widened. However, if each coefficient is larger than “coefficient U0×(1+0.4)”, there is a high possibility that a facial region in an image, which is obtained by trimming a facial photograph image, would become too small. Further, if each coefficient is smaller than “coefficient U0×(1−0.4)”, there is a high possibility that the whole facial region is not included in the trimming area. Therefore, even if the output format is not strict, it is preferable to use values within the range of “coefficient U0×(1±0.40)” as the coefficients U4a, U4b and U4c.

A fifth image processing apparatus according to the present invention is an image processing apparatus comprising:
a top-of-head detection means for detecting the position of the top of a head from the part above the positions of eyes in a facial photograph image and calculating the perpendicular distance H from the eyes to the top of the head; and
a trimming area setting means for setting a trimming area by using each of values L5a, L5b and L5c, which are obtained by performing operations according to equations (21) by using the distance D between both eyes and the perpendicular distance H in the facial photograph image and coefficients U5a, U5b and U5c, as the lateral width of the trimming area with its middle in the lateral direction at the middle position Gm between both eyes in the facial photograph image, the distance from the middle position Gm to the upper side of the trimming area, and the distance from the middle position Gm to the lower side of the trimming area, respectively, wherein the coefficients U5a, U5b and U5c are obtained by performing processing on a multiplicity of sample facial photograph images to obtain absolute values of differences between each value of Lt5a, Lt5b and Lt5c, which are obtained by performing operations according to equations (22) by using the perpendicular distance Hs from eyes to the top of a head and the distance Ds between both eyes in each of the sample facial photograph images and predetermined test coefficients Ut5a, Ut5b and Ut5c, and the lateral width of a predetermined trimming area with its middle in the lateral direction at the middle position of both eyes, the distance from the middle position between both eyes to the upper side of the trimming area and the distance from the middle position between both eyes to the lower side of the trimming area, respectively, in each of the sample facial photograph images and optimizing the test coefficients so that the sum of the absolute values of the differences, which are obtained for each of the sample facial photograph images, is minimized.
   L5a=D×U5a
   L5b=H×U5b (21)
   L5c=H×U5c
   Lt5a=Ds×Ut5a
   Lt5b=Hs×Ut5b (22)
   Lt5c=Hs×Ut5c

Here, the distance between the pupils of both eyes may be used as the distance between both eyes. In this case, it is preferable that each value of the coefficients U5a, U5b and U5c is within the range of (5.04×range coefficient), (1.495×range coefficient) or (1.89×range coefficient), respectively. The range coefficient may be (1±0.4).

Further, it is preferable that the range coefficient is changed to (1±0.25), (1±0.10), or (1±0.05) as the output format becomes stricter.

A sixth image processing apparatus according to the present invention is an image processing apparatus comprising:
a top-of-head detection means for detecting the position of the top of a head from the part above the positions of eyes in a facial photograph image and calculating the perpendicular distance H from the eyes to the top of the head; and
a trimming area setting means for setting a trimming area by using each of values L6a, L6b and L6c, which are obtained by performing operations according to equations (23) by using the distance D between both eyes and the perpendicular distance H in the facial photograph image and coefficients U6a, U6b1, U6c1, U6b2 and U6c2, as the lateral width of the trimming area with its middle in the lateral direction at the middle position Gm between both eyes in the facial photograph image, the distance from the middle position Gm to the upper side of the trimming area, and the distance from the middle position Gm to the lower side of the trimming area, respectively, wherein the coefficients U6a, U6b1, U6c1, U6b2 and U6c2 are obtained by performing processing on a multiplicity of sample facial photograph images to obtain absolute values of differences between each value of Lt6a, Lt6b and Lt6c, which are obtained by performing operations according to equations (24) by using the perpendicular distance Hs from eyes to the top of a head and the distance Ds between both eyes in each of the sample facial photograph images and predetermined test coefficients Ut6a, Ut6b1, Ut6c1, Ut6b2 and Ut6c2, and the lateral width of a predetermined trimming area with its middle in the lateral direction at the middle position of both eyes, the distance from the middle position between both eyes to the upper side of the trimming area and the distance from the middle position between both eyes to the lower side of the trimming area, respectively, in each of the sample facial photograph images and optimizing the test coefficients so that the sum of the absolute values of the differences, which are obtained for each of the sample facial photograph images, is minimized.
   L6a=D×U6a
   L6b=D×U6b1+H×U6c1 (23)
   L6c=D×U6b2+H×U6c2
   Lt6a=Ds×Ut6a
   Lt6b=Ds×Ut6b1+Hs×Ut6c1 (24)
   Lt6c=Ds×Ut6b2+Hs×Ut6c2

Further, the distance between the pupils of both eyes may be used as the distance between both eyes. In this case, each value of the coefficients U6a, U6b1, U6c1, U6b2 and U6c2 may be within the range of (5.04×range coefficient), (2.674×range coefficient), (0.4074×range coefficient), (0.4926×range coefficient) or (1.259×range coefficient), respectively. The range coefficient may be (1±0.4).

It is preferable to change the range coefficient from (1±0.25) to (1±0.10) and to (1±0.05) as the output format becomes stricter.

The positions of the eyes in the facial photograph image can be indicated much more easily and accurately than the position of the top of the head or the position of the tip of the chin in the facial photograph image. Therefore, in the image processing apparatus according to the present invention, the positions of the eyes in the facial photograph image may be indicated by an operator. However, it is preferable to further provide an eye detection means in the image processing apparatus according to the present invention to reduce human operations and improve the efficiency in processing. The eye detection means detects the positions of eyes in the facial photograph image and calculates the distance D between both eyes and the middle position Gm between both eyes based on the detected positions of the eyes.

Further, in recent years, the functions of digital cameras (including digital cameras attached to cellular phones) have rapidly improved. However, there are limitations in the size of display screens of the digital cameras. In some cases, a user needs to check a facial region in a facial photograph image by displaying it on a display screen of a digital camera. Further, there is a need to transmit an image including only a facial region to a server on a network. There is also a need to send an image including only the facial region to a laboratory so that the image is printed out at the laboratory. Therefore, people desire digital cameras that can efficiently trim an image to leave a facial region.

A digital camera according to the present invention is a digital camera, to which the image processing apparatus according to the present invention is applied, comprising:
a photographing means;
a trimming area obtainment means for obtaining a trimming area in a facial photograph image, which is obtained by the photographing means; and
a trimming performing means for obtaining a trimming image by performing trimming on the facial photograph image based on the trimming area, which is obtained by the trimming area obtainment means, wherein the trimming area obtainment means is the image processing apparatus according to the present invention.

Further, the image processing apparatus according to the present invention may be applied to a photography box apparatus. Specifically, the photography box apparatus according to the present invention is a photography box apparatus comprising:
a photographing means;
a trimming area obtainment means for obtaining a trimming area in a facial photograph image, which is obtained by the photographing means; and
a trimming performing means for obtaining a trimming image by performing trimming on the facial photograph image based on the trimming area, which is obtained by the trimming area obtainment means, wherein the trimming area obtainment means is the image processing apparatus according to the present invention.

Here, the “photography box apparatus” according to the present invention refers to an automatic photography box, which automatically performs processes from taking a photograph to printing the photograph. Needless to say, the photography box apparatus according to the present invention includes a photography box apparatus for obtaining identification photographs, which is installed at stations, in downtown, or the like. The photography box apparatus according to the present invention also includes a “Purikura” machine or the like.

The image processing method according to the present invention may be provided as a program for causing a computer to execute the image processing method.

According to the first image processing method and apparatus of the present invention, a facial frame is obtained by using the positions of eyes and the distance between both eyes in a facial photograph image, and a trimming area in the facial photograph image is set based on the size and the position of the obtained facial frame to satisfy a predetermined output format. Therefore, processing is facilitated.

According to the fourth image processing method and apparatus of the present invention, a trimming area is directly set by using the positions of eyes and the distance between both eyes in the facial photograph image. Therefore, processing is further facilitated.

Further, the positions of the eyes can be indicated more easily and accurately than the top of a head and the tip of a chin. Therefore, even if an operator is required to manually indicate the positions of the eyes in the facial photograph image in the present invention, the work load on the operator is not so heavy. Further, it is also possible to provide an eye detection means for automatically detecting eyes. In this case, since detection of only the positions of the eyes is required, processing can be performed efficiently.

According to the second and third image processing methods and apparatuses of the present invention, the position of the top of a head is detected from the part above the positions of the eyes in a facial photograph image, and a facial frame is obtained based on the positions of the eyes, the distance between both eyes and the position of the top of a head. Since the top of the head is detected from a limited area, which is the part above the positions of the eyes, processing can be performed quickly. Further, the position of the top of the head may be detected without being affected by the color of person's clothes, or like. Consequently, an appropriate trimming area can be set.

According to the fifth and six image processing methods and apparatuses, the position of the top of a head is detected from the part above the positions of eyes in a facial photograph image, and a trimming area is directly set based on the positions of the eyes, the distance between both eyes, and the position of the top of the head. Therefore, since the top of the head is detected from a limited area, which is the part above the positions of the eyes, processing can be performed quickly. Further, the position of the top of the head can be detected accurately without being affected by the color of person's clothes. Consequently, an appropriate trimming area can be set.

A digital camera and a photography box apparatus, to which the image processing apparatus according to the present invention is applied, can efficiently perform trimming on an image to leave a facial region. Therefore, a high quality trimming image can be obtained. Particularly, in the photography box apparatus, even if a person, who is a photography subject, sits off from a standard position, or the like, a photograph desired by the user can be obtained. Problems, such as a part of the face not being included in the image, do not arise.

### BRIEF DESCRIPTION OF THE DRAWINGS

FIG. 1 is a block diagram illustrating an image processing system A according to a first embodiment of the present invention;

FIG. 2 is a block diagram illustrating an eye detection unit 1;

FIG. 3A is a diagram for explaining the center positions of eyes;

FIG. 3B is a diagram for explaining the center positions of eyes;

FIG. 4A is a diagram illustrating an edge detection filter in a horizontal direction;

FIG. 4B is a diagram illustrating an edge detection filter in a vertical direction;

FIG. 5 is a diagram for explaining gradient vector calculation;

FIG. 6A is a diagram illustrating a human face;

FIG. 6B is a diagram illustrating gradient vectors in the vicinity of the eyes and the vicinity of the mouth in the human face, which is illustrated in FIG. 6A;

FIG. 7A is a histogram of the magnitude of gradient vectors prior to normalization;

FIG. 7B is a histogram of the magnitude of gradient vectors after normalization;

FIG. 7C is a histogram of the magnitude of gradient vectors, which is quinarized;

FIG. 7D is a histogram of the magnitude of gradient vectors after normalization, which is quinarized;

FIG. 8 is an example of sample images, which are recognized as facial images and used for learning to obtain first reference data;

FIG. 9 is an example of sample images, which are recognized as facial images and used for learning to obtain second reference data;

FIG. 10A is a diagram for explaining rotation of a face;

FIG. 10B is a diagram for explaining rotation of the face;

FIG. 10C is a diagram for explaining rotation of the face;

FIG. 11 is a flow chart illustrating a method for learning to obtain reference data;

FIG. 12 is a diagram for generating a distinguisher;

FIG. 13 is a diagram for explaining stepwise deformation of a distinction target image;

FIG. 14 is a flow chart illustrating processing at the eye detection unit 1;

FIG. 15 is a block diagram illustrating the configuration of a center-position-of-pupil detection unit 50;

FIG. 16 is a diagram for explaining a trimming position by a second trimming unit 10;

FIG. 17 is a diagram for explaining how to obtain a threshold value for binarization;

FIG. 18 is a diagram for explaining weighting of vote values;

FIG. 19 is a flow chart illustrating processing by the eye detection unit 1 and the center-position-of-pupil detection unit 50;

FIG. 20 is a block diagram illustrating the configuration of a trimming area obtainment unit 60a;

FIG. 21 is a flow chart illustrating processing in the image processing system A, which is illustrated in FIG. 1;

FIG. 22 is a block diagram illustrating the configuration of an image processing system B according to a second embodiment of the present invention;

FIG. 23 is a block diagram for illustrating the configuration of a trimming area obtainment unit 60b;

FIG. 24 is a flow chart illustrating processing in the image processing system B, which is illustrated in FIG. 22;

FIG. 25 is a block diagram illustrating the configuration of an image processing system C according to a third embodiment of the present invention;

FIG. 26 is a flow chart illustrating processing in the image processing system C, which is illustrated in FIG. 25;

FIG. 27 is a block diagram illustrating the configuration of an image processing system D according to a fourth embodiment of the present invention;

FIG. 28 is a block diagram illustrating the configuration of a trimming area obtainment unit 60d;

FIG. 29 is a flow chart illustrating processing in the image processing system, which is illustrated in FIG. 27; and

FIG. 30 is a diagram illustrating an example of the distance between both eyes.

### DESCRIPTION OF THE PREFERRED EMBODIMENTS

Hereinafter, embodiments of the present invention will be described with reference drawings.

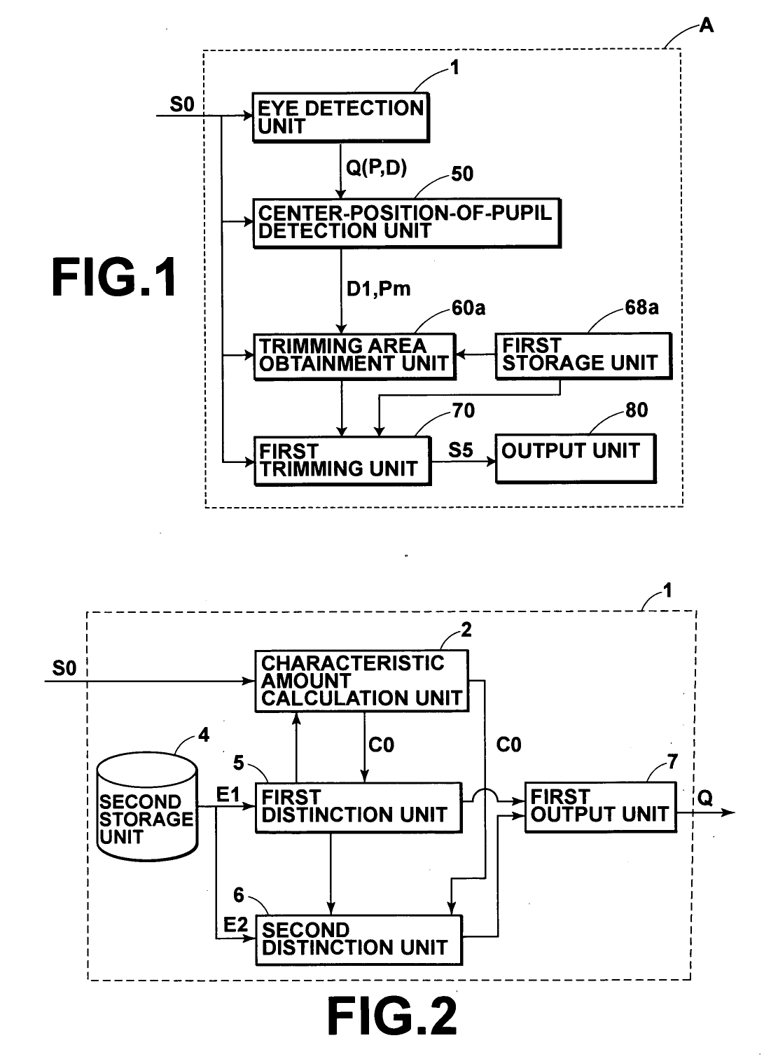

FIG. 1 is a block diagram illustrating the configuration of an image processing system A according to a first embodiment of the present invention. As illustrated in FIG. 1, the image processing system A in the present embodiment includes an eye detection unit 1 for distinguishing whether a facial region is included in an input photograph image S0. If the facial region is not included in the input photograph image S0, the eye detection unit 1 stops processing on the photograph image S0. If a facial region is included in the photograph image S0 (that is, the photograph image S0 is a facial photograph image), the eye detection unit 1 further detects a left eye and a right eye and obtains information Q, which includes the positions Pa and Pb of both eyes and the distance D between both eyes. (Here, the distance D is the distance 3d between the centers of both eyes, which is illustrated in FIG. 30.) The image processing system A also includes a center-position-of-pupil detection unit 50 for detecting the center positions G′a and G′b of the pupils of both eyes based on the information Q received from the eye detection unit 1. The center-position-of-pupil detection unit 50 also obtains the distance D1 between the two pupils (Here, the distance D1 is the distance d1, which is illustrated in FIG. 30), and obtains the middle position Pm between both eyes based on the positions Pa and Pb of both eyes, which are included in the information Q. The image processing system A also includes a trimming area obtainment unit 60a for obtaining a facial frame in the facial photograph image S0 based on the middle position Pm between both eyes, the distance D1 between the pupils and coefficients U1a, U1b and U1c, which are stored in a first storage unit 68a, which will be described later. The trimming area obtainment unit 60a also sets a trimming area based on the calculated position and size of the facial frame. The image processing system A also includes a first trimming unit 70 for obtaining a trimming image S5 by trimming the facial photograph image S0 based on the trimming area obtained by the trimming area obtainment unit 60a. The image processing system A also includes an output unit 80 for producing an identification photograph by printing out the trimming image S5. The image processing system A also includes a first storage unit 68a for storing the coefficients U1a, U1b and U1c and other data (output format, etc.), which are required by the trimming area obtainment unit 60a and the first trimming unit 70.

Each element in the image processing system A, which is illustrated in FIG. 1, will be described below in detail.

First, the eye detection unit 1 will be described in detail.

FIG. 2 is a block diagram illustrating the configuration of the eye detection unit 1 in detail. As illustrated in FIG. 2, the eye detection unit 1 includes a characteristic amount calculation unit 2 for calculating a characteristic amount C0 from the photograph image S0 and a second storage unit 4, which stores first reference data E1 and second reference data E2, which will be described later. The eye detection unit 1 also includes a first distinction unit 5 for distinguishing whether the photograph image S0 includes a human face based on the characteristic amount C0, which is calculated by the characteristic amount calculation unit 2, and the first reference data E1, which is stored in the second storage unit 4. The eye detection unit 1 also includes a second distinction unit 6. If the first distinction unit 5 distinguishes that the photograph image S0 includes a face, the second distinction unit 6 detects the positions of eyes included in the face based on the characteristic amount C0 of the facial image, which is calculated by the characteristic amount calculation unit 2, and the second reference data E2 stored in the second storage unit 4. The eye detection unit 1 also includes a first output unit 7.

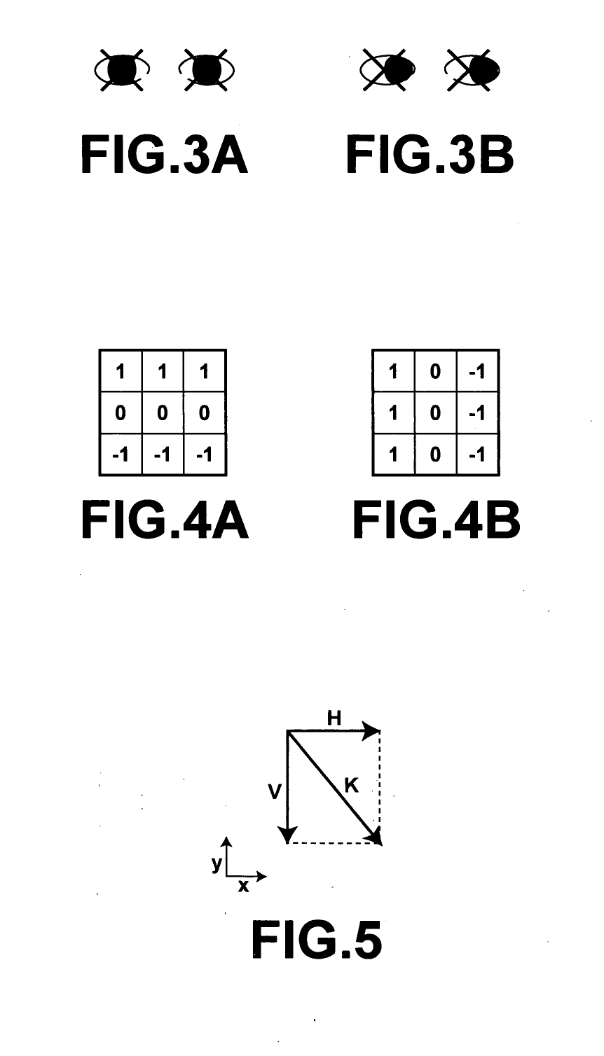

The position of the eye, which is detected by the eye detection unit 1, is the middle position between the outer corner of an eye and the inner corner of the eye in a face, (which is indicated with the mark “×” in FIGS. 3A and 3B). As illustrated in FIG. 3A, if the eyes point to the front, the positions of the eyes are similar to the center positions of the pupils. However, as illustrated in FIG. 3B, if the eyes point to the right, the positions of the eyes are not the center positions of the pupils but positions off from the centers of the pupils, or positions in the whites of the eyes.

The characteristic amount calculation unit 2 calculates the characteristic amount C0, which is used for distinguishing a face, from the photograph image S0. Further, if it is distinguished that a face is included in the photograph image S0, the characteristic amount calculation unit 2 calculates a similar characteristic amount C0 from the facial image, which is extracted as will be described later. Specifically, a gradient vector (namely, the direction of change and the magnitude of change in the density at each pixel in the photograph image S0 and the facial image) is calculated as the characteristic amount C0. Calculation of the gradient vector will be described below. First, the characteristic amount calculation unit 2 performs filtering processing on the photograph image S0 by using a horizontal edge detection filter, which is illustrated in FIG. 4A, and detects an edge in the horizontal direction in the photograph image S0. Further, the characteristic amount calculation unit 2 performs filtering processing on the photograph image S0 by using a vertical edge detection filter, which is illustrated in FIG. 4B, and detects an edge in the vertical direction in the photograph image S0. Then, the characteristic amount calculation unit 2 calculates a gradient vector K at each pixel based on the magnitude H of the edge in the horizontal direction and the magnitude V of the edge in the vertical direction at each pixel in the photograph image S0, as illustrated in FIG. 5. Further, the gradient vector K is also calculated for the facial image in a similar manner. The characteristic amount calculation unit 2 calculates the characteristic amount C0 at each stage of deformation of the photograph image S0 and the facial image as will be described later.

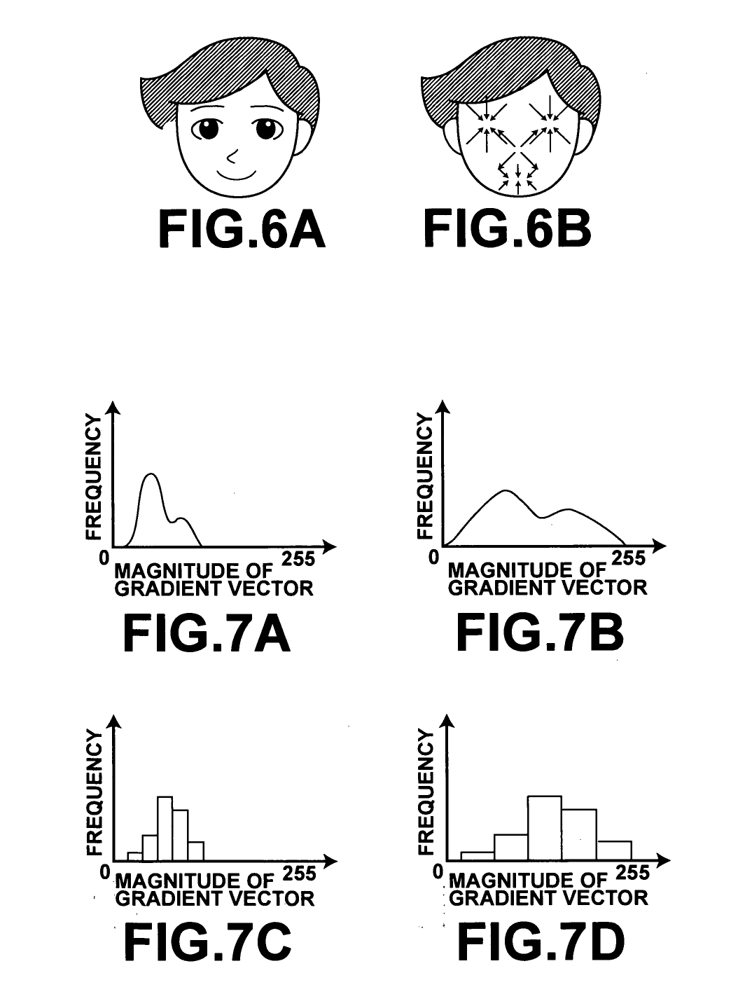

If the image includes a human face as illustrated in FIG. 6A, the gradient vectors K, which are calculated as described above, point to the center of each of eyes and the center of a mouth in a dark area such as the eyes and the mouth as illustrated in FIG. 6B. The gradient vectors K point to the outside from the position of a nose in a bright area such as the nose as illustrated in FIG. 6B. Further, since the density change in the region of the eyes is larger than the density change in the region of the mouth, the gradient vectors K in the region of the eyes are larger than the gradient vectors K in the region of the mouth.

Then, the direction and the magnitude of the gradient vector K are used as the characteristic amount C0. The direction of the gradient vector K is represented by values from 0 to 359 degrees with respect to a predetermined direction of the gradient vector K (the x direction in FIG. 5, for example).

Here, the magnitude of the gradient vector K is normalized. The normalization is performed by obtaining a histogram of the magnitudes of the gradient vectors K at all the pixels in the photograph image S0. The histogram is smoothed so that the magnitudes of the gradient vectors K are evenly distributed to all the range of values, which may represent the magnitude of the gradient vector K at each pixel of the photograph image S0 (0 to 255 in the case of 8 bits). Then, the magnitudes of the gradient vectors K are corrected. For example, if the magnitudes of the gradient vectors K are small, the magnitudes are mostly distributed in the smaller value side of the histogram as illustrated in FIG. 7A. In such a case, the magnitudes of the gradient vectors K are normalized so that the magnitudes of the gradient vectors K are distributed across the entire range of 0 to 255. Accordingly, the magnitudes become distributed in the histogram as illustrated in FIG. 7B. Further, to reduce the operation amount, it is preferable to divide the distribution range of the magnitudes of the gradient vectors K in the histogram into five parts, for example, as illustrated in FIG. 7C. It is preferable to normalize the magnitudes of the gradient vectors K so that the frequency distributions, which are divided into five, are spread to all the range of values from 0 to 255, which are divided into five, as illustrated in FIG. 7D.

The first and second reference data E1 and E2, which are stored in the second storage unit 4, define distinction conditions about the combination of the characteristic amounts C0 at each pixel, which forms each pixel group. The distinction conditions are defined regarding each of a plurality of kinds of pixel groups, which include a plurality of pixels, which are selected from a sample image, to be described later.

The combination of the characteristic amounts C0 and the distinction conditions at each pixel, which forms each pixel group, in the first and second reference data E1 and E2 are determined in advance. The combination of the characteristic amounts C0 and the distinction conditions are obtained by learning using a sample image group, which includes a plurality of sample images, which are recognized as facial images, and a plurality of sample images, which are recognized as non-facial images.

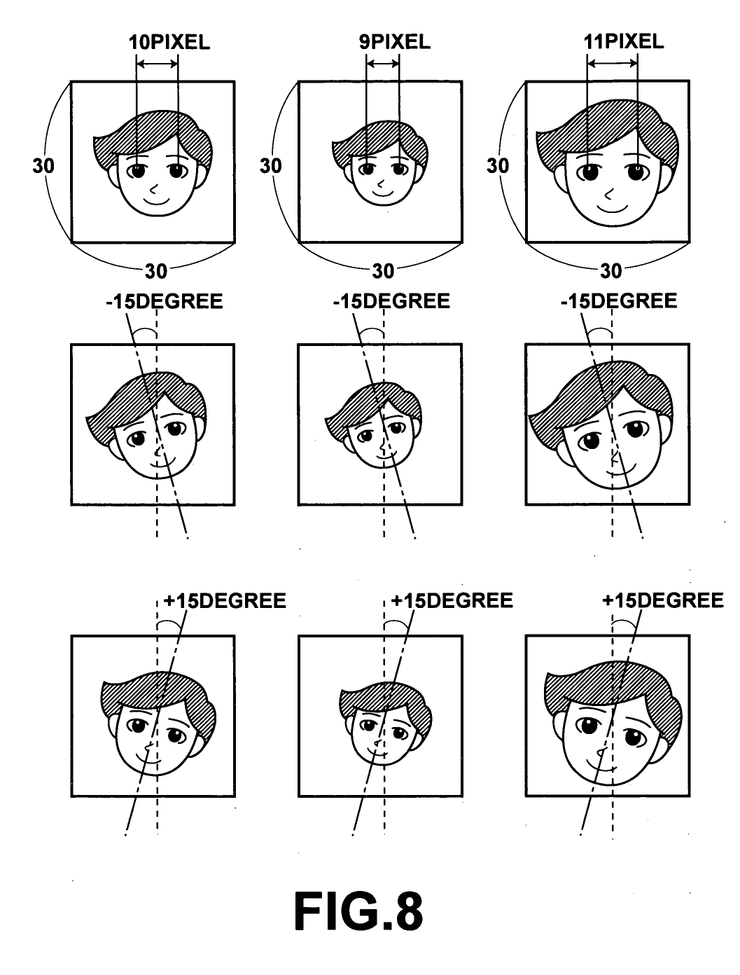

In the present embodiment, it is assumed that, to generate the first reference data E1, sample images, which have the size of 30×30 pixels, are used as the sample images, which are recognized as facial images. It is also assumed that the sample images as illustrated in FIG. 8 are used for a single facial image. In the sample image, the distances between the centers of both eyes are 10 pixels, 9 pixels and 11 pixels, and the face, which is vertical at the middle position between the centers of both eyes, is rotated on a plane in 3 degree increments in a stepwise manner within the range of ±15 degrees (namely, the rotation angles are −15 degrees, −12 degrees, −9 degrees, −6 degrees, −3 degrees, 0 degree, 3 degrees, 6 degrees, 9 degrees, 12 degrees, and 15 degrees). Therefore, 3×11=33 kinds of sample images are prepared from the single facial image. In FIG. 8, only samples image, which are rotated −15 degrees, 0 degree and +15 degrees, are illustrated. Further, the center of the rotation is the intersection of diagonal lines in the sample images. Here, in the sample images, in which the distance between the centers of both eyes is 10 pixels, the center positions of the eyes in all of the sample images are the same. It is assumed that the center positions of the eyes are (x1, y1) and (x2, y2) in the coordinates with the origin at the upper left corner of the sample image. Further, the positions of the eyes in the vertical direction (namely, y1 and y2) are the same for all of the sample images in FIG. 8.

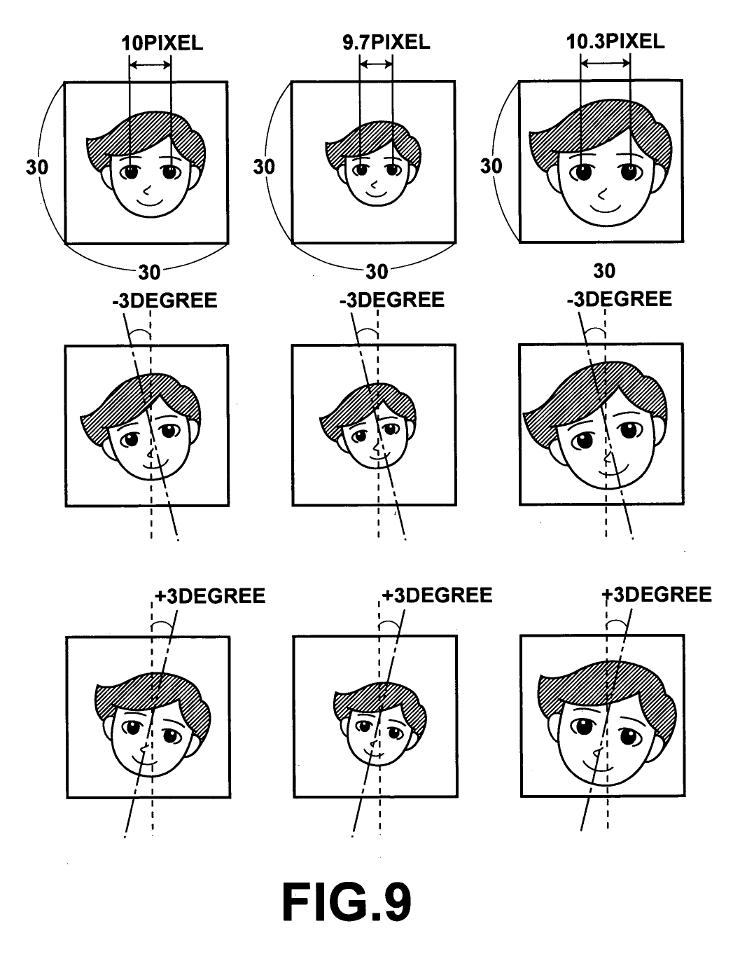

Further, it is assumed that, to generate the second reference data E2, sample images, which have the size of 30×30 pixels, are used as the sample images, which are recognized as facial images. It is also assumed that sample images as illustrated in FIG. 9 are used for a single facial image. In the sample images, the distances between the centers of both eyes are 10 pixels, 9.7 pixels and 10.3 pixels, and a face, which is vertical at the middle position between the centers of both eyes, is rotated on a plane in 1 degree increments in a stepwise manner within the range of ±3 degrees (namely, the rotation angles are −3 degrees, −2 degrees, −1 degree, 0 degree, 1 degree, 2 degrees and 3 degrees). Therefore, 3×7=21 kinds of sample images are prepared from the single facial image. In FIG. 9, only samples images, which are rotated −3 degrees, 0 degree and +3 degrees, are illustrated. Further, the center of the rotation is the intersection of diagonal lines in the sample images. Here, the positions of the eyes in the vertical direction are the same for all of the sample images in FIG. 9. The sample images, in which the distances between the centers of both eyes are 10 pixels, should be reduced 9.7 times or enlarged 10.3 times so that the distances between the centers of both eyes are changed from 10 pixels to 9.7 pixels or 10.3 pixels. The size of the sample images after reduction or enlargement should be 30×30 pixels.

Further, the center positions of the eyes in the sample images, which are used for learning to obtain the second reference data E2, are the positions of the eyes, which are distinguished in the present embodiment.

It is assumed that an arbitrary image, which has the size of 30×30 pixels, is used as the sample image, which is recognized as a non-facial image.

Here, if learning is performed by using only a sample image, in which the distance between the centers of both eyes is 10 pixels and the rotation angle on a plane is 0 degree (namely, the face is vertical), as a sample image, which is recognized as a facial image, the position of the face or the positions of the eyes can be distinguished with reference to the first reference data E1 and the second reference data E2 only in the case the distance between the centers of both eyes is 10 pixels and the face is not rotated at all. The size of faces, which may be included in the photograph image S0, is not the same. Therefore, for distinguishing whether a face is included in the photograph image S0, or distinguishing the positions of the eyes, the photograph image S0 is enlarged or reduced as will be described later so that the size of the face is in conformity with the size of the sample image. Accordingly, the face and the positions of the eyes can be distinguished. However, to accurately change the distance between the centers of both eyes to 10 pixels, the size of the photograph image S0 is required to be enlarged or reduced in a stepwise manner by changing the enlargement ratio of the size of the photograph image S0 in 1.1 units, for example, during distinction. Therefore, the operation amount becomes excessive.

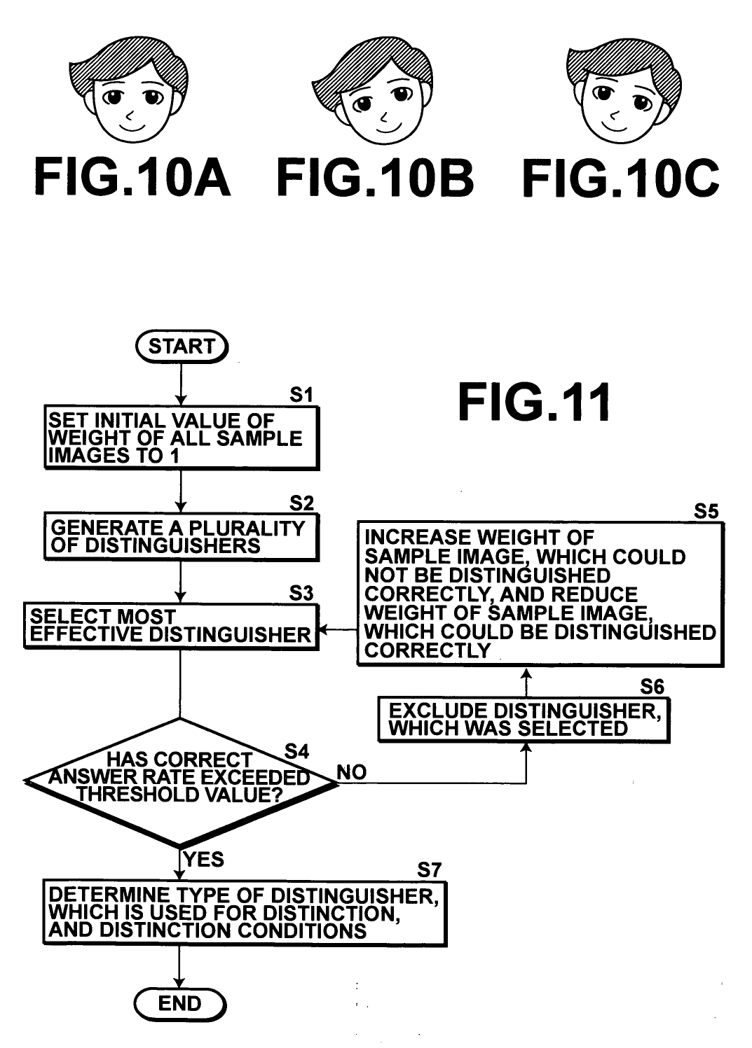

Further, the photograph image S0 may include rotated faces as illustrated in FIGS. 10B and 10C as well as a face, of which rotation angle on a plane is 0 degree, as illustrated in FIG. 10A. However, if only sample images, in which the distance between the centers of the eyes is 10 pixels and the rotation angle of the face is 0 degree, are used for learning, although rotated faces are faces, the rotated faces as illustrated in FIGS. 10B and 10C may not be distinguished.

Therefore, in the present embodiment, the sample images as illustrated in FIG. 8 are used as the sample images, which are recognized as facial images. In FIG. 8, the distances between the centers of both eyes are 9 pixels, 10 pixels or 11 pixels, and the face is rotated on a plane in 3 degree increments in a stepwise manner within the range of ±15 degrees for each of the distances between the centers of both eyes. Accordingly, the allowable range of the reference data E1, which is obtained by learning, becomes wide. When the first distinction unit 5, which will be described later, performs distinction processing, the photograph image S0 should be enlarged or reduced in a stepwise manner by changing the enlargement ratio in 11/9 units. Therefore, the operation time can be reduced in comparison with the case of enlarging or reducing the size of the photograph image S0 in a stepwise manner by changing the enlargement ratio in 1.1 units, for example. Further, the rotated faces as illustrated in FIGS. 10B and 10C may also be distinguished.

Meanwhile, the sample images as illustrated in FIG. 9 are used for learning the second reference data E2. In the sample images, the distances between the centers of both eyes are 9.7 pixels, 10 pixels, and 10.3 pixels, and the face is rotated on a plane in 1 degree increments in a stepwise manner within the range of ±3 degrees for each of the distances between the centers of both eyes. Therefore, the allowable range of learning of the second reference data E2 is smaller than that of the first reference data E1. Further, when the second distinction unit 6, which will be described later, performs distinction processing, the photograph image S0 is required to be enlarged or reduced by changing the enlargement ratio in 10.3/9.7 units. Therefore, a longer operation time is required than that of the distinction processing by the first distinction unit 5. However, since the second distinction unit 6 performs distinction processing only on the image within the face, which is distinguished by the first distinction unit 5, the operation amount for distinguishing the positions of the eyes can be reduced when compared with distinguishing the positions of the eyes by using the whole photograph image S0.

An example of a learning method by using a sample image group will be described below with reference to the flow chart of FIG. 11. Here, learning of the first reference data E1 will be described.

The sample image group, which is a learning object, includes a plurality of sample images, which are recognized as facial images, and a plurality of sample images, which are recognized as non-facial images. For each sample image, which is recognized as the facial image, images, in which the distances between the centers of both eyes are 9 pixels, 10 pixels or 11 pixels and a face is rotated on a plane in 3 degree increments in a stepwise manner within the range of ±15 degrees, are used. Weight, namely the degree of importance, is assigned to each of the sample images. First, an initial weight value is equally set to 1 for all of the sample images (step S1).

Next, a distinguisher is generated for each of a plurality of kinds of pixel groups in the sample images (step S2). Here, each distinguisher provides criteria for distinguishing a facial image from a non-facial image by using the combination of the characteristic amounts C0 at each pixel, which forms a single pixel group. In the present embodiment, a histogram of the combination of the characteristic amounts C0 at each pixel, which forms the single pixel group, is used as the distinguisher.

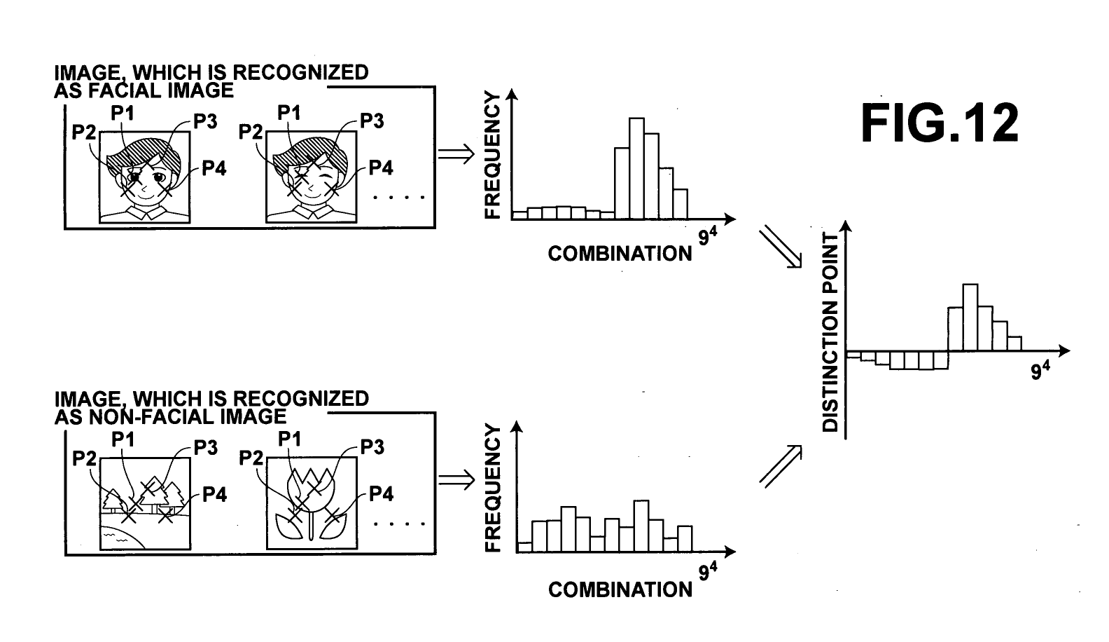

Generation of the distinguisher will be described below with reference to FIG. 12. As illustrated in the sample images in the left side of FIG. 12, a pixel group for generating the distinguisher includes a pixel P1 at the center of the right eye, a pixel P2 in the right cheek, a pixel P3 in the forehead and a pixel P4 in the left cheek in each of a plurality of sample images, which are recognized as facial images. Then, the combinations of the characteristics values C0 at all of the pixels P1-P4 are obtained for all of the sample images, which are recognized as facial images, and a histogram of the combinations of the characteristics values is generated. Here, the characteristics value C0 represents the direction and the magnitude of the gradient vector K. The direction of the gradient vector K can be represented by 360 values of 0 to 359, and the magnitude of the gradient vector K can be represented by 256 values of 0 to 255. Therefore, if all the values, which represent the direction, and the values, which represent the magnitude, are used, the number of combinations is 360×256 for a pixel, and the number of combinations is (360×256)⁴ for the four pixels. Therefore, a huge number of samples, a long time and a large memory are required for learning and detecting. Therefore, in the present embodiment, the values of the direction of the gradient vector, which are from 0 to 359, are quarternarized. The values from 0 to 44 and from 315 to 359 (right direction) are represented by the value of 0, the values from 45 to 134 (upper direction) are represented by the value of 1, the values from 135 to 244 (left direction) are represented by the value of 2, and the values from 225 to 314 (lower direction) are represented by the value of 3. The values of the magnitude of the gradient vectors are ternarized (values: 0 to 2). The value of combination is calculated by using the following equations:
Value of Combination=0
(if Magnitude of Gradient Vector=0),
Value of Combination=(Direction of Gradient Vector+1)×Magnitude of Gradient Vector
(if Magnitude of Gradient Vector>0).

Accordingly, the number of combinations becomes 9⁴. Therefore, the number of sets of data of the characteristic amounts C0 can be reduced.

A histogram regarding the plurality of sample images, which are recognized as non-facial images, is also generated in a similar manner. To generate the histogram about the sample images, which are recognized as non-facial images, pixels corresponding to the positions of the pixels P1-P4 in the sample images, which are recognized as facial images, are used. The logarithmic value of the ratio between the frequency values represented by the two histograms is calculated. The calculated values are represented in a histogram as illustrated in the right side of FIG. 12. This histogram is used as the distinguisher. Each value on the vertical axis of this histogram, which is the distinguisher, is hereinafter called a distinction point. According to this distinguisher, if the distribution of the characteristic amounts C0 of an image corresponds to positive distinction points, the possibility that the image is a facial image is high. If the absolute value of the distinction point is larger, the possibility is higher. In contrast, if the distribution of the characteristic amounts C0 of an image corresponds to negative distinction points, the possibility that the image is a non-facial image is high. If the absolute value of the distinction point is larger, the possibility is higher. In step S2, a plurality of distinguishers, which may be used for distinction, is generated. The plurality of distinguishers is in the form of a histogram. The histogram is generated regarding the combination of the characteristic amounts C0 at each pixel, which forms a plurality of kinds of pixel groups as described above.

Then, the most effective distinguisher for distinguishing whether the image is a facial image is selected from the plurality of distinguishers, which were generated in step S2. Weight of each sample image is considered to select the most effective distinguisher. In this example, a weighted rate of correct answers of each distinguisher is compared with each other, and a distinguisher, of which the weighted rate of correct answers is the highest, is selected as the most effective distinguisher (step S3). Specifically, in the first step S3, the weight of each sample image is equally 1. Therefore, a distinguisher, which can correctly distinguish whether an image is a facial image regarding a largest number of sample images, is simply selected as the most effective distinguisher. Meanwhile, in the second step S3 after the weight of each sample image is updated in step S5, which will be described later, there are sample images, of which the weight is 1, sample images, of which the weight is larger than 1, and sample image, of which the weight is smaller than 1. Therefore, when the rate of correct answers is evaluated, the sample image, of which the weight is larger than 1, is counted more than the sample image, of which the weight is 1. Accordingly, in the second step S3 or later step S3, processing is focused on correctly distinguishing a sample image, of which the weight is large, than correctly distinguishing a sample image, of which the weight is small.

Next, processing is performed to check whether the rate of correct combination of the distinguishers, which have been selected, has exceeded a predetermined threshold value (step S4). The rate of correct combination of the distinguishers is the rate that the result of distinguishing whether each sample image is a facial image by using the combination of the distinguishers, which have been selected, is the same as the actual answer on whether the image is a facial image. Here, either the present sample image group after weighting or the equally weighted sample image group may be used to evaluate the rate of correct combination. If the rate exceeds the predetermined threshold value, the probability of distinguishing whether the image is a facial image by using the distinguishers, which have been selected so far, is sufficiently high. Therefore, learning ends. If the rate is not higher than the predetermined threshold value, processing goes to step S6 to select an additional distinguisher, which will be used in combination with the distinguishers, which have been selected so far.

In step S6, the distinguisher, which was selected in the most recent step S3, is excluded so as to avoid selecting the same distinguisher again.

Next, if a sample image is not correctly distinguished as to whether the image is a facial image by using the distinguisher, which was selected in the most recent step S3, the weight of the sample image is increased. If a sample image is correctly distinguished as to whether the image is a facial image, the weight of the sample image is reduced (step S5). The weight is increased or reduced as described above to improve the effects of the combination of the distinguishers. When the next distinguisher is selected, the selection is focused on the images, which could not be correctly distinguished by using the distinguishers, which have been already selected. A distinguisher, which can correctly distinguish the images as to whether they are facial images, is selected as the next distinguisher.

Then, processing goes back to step S3, and the next most effective distinguisher is selected based on the weighted rate of correct answers as described above.

Processing in steps S3-S6 as described above is repeated. When a distinguisher, which corresponds to the combination of the characteristic amount C0 at each pixel, which forms a specific pixel group, has been selected as an appropriate distinguisher for distinguishing whether an image includes a face, if the rate of correct combination, which is checked in step S4, exceeds a threshold value, the type of the distinguisher, which will be used for distinguishing whether a face is included, and the distinction conditions are determined (step S7). Accordingly, learning of the first reference data E1 ends.

Then, learning of the second reference data E2 is performed by obtaining the type of the distinguisher and the distinction conditions in a manner similar to the method as described above.

When the learning method as described above is adopted, the distinguisher may be in any form and is not limited to the histogram as described above, as long as the distinguisher can provide criteria for distinguishing a facial image from a non-facial image by using the combination of the characteristic amounts C0 at each pixel, which forms a specific pixel group. For example, the distinguisher may be binary data, a threshold value, a function, or the like. Further, other kinds of histograms such as a histogram showing the difference value between the two histograms, which are illustrated at the center of FIG. 12, may also be used.

The learning method is not limited to the method as described above. Other machine learning methods such as a neural network method may also be used.

The first distinction unit 5 refers to the distinction conditions, which were learned by the first reference data E1 about all of the combinations of the characteristic amount C0 at each pixel, which forms a plurality of kinds of pixel groups. The first distinction unit 5 obtains a distinction point for the combination of the characteristic amount C0 at each pixel, which forms each pixel group. Then, the first distinction unit 5 distinguishes whether a face is included in the photograph image S0 by using all of the distinction points. At this time, the direction of the gradient vector K, which is a characteristic amount C0, is quaternarized, and the magnitude of the gradient vector K, which is a characteristic amount C0, is ternarized. In the present embodiment, all the distinction points are added, and distinction is carried out based on whether the sum is a positive value or a negative value. For example, if the sum of the distinction points is a positive value, it is judged that the photograph image S0 includes a face. If the sum of the distinction points is a negative value, it is judged that the photograph image S0 does not include a face. The processing, which is performed by the first distinction unit 5, for distinguishing whether the photograph image S0 includes a face is called first distinction.

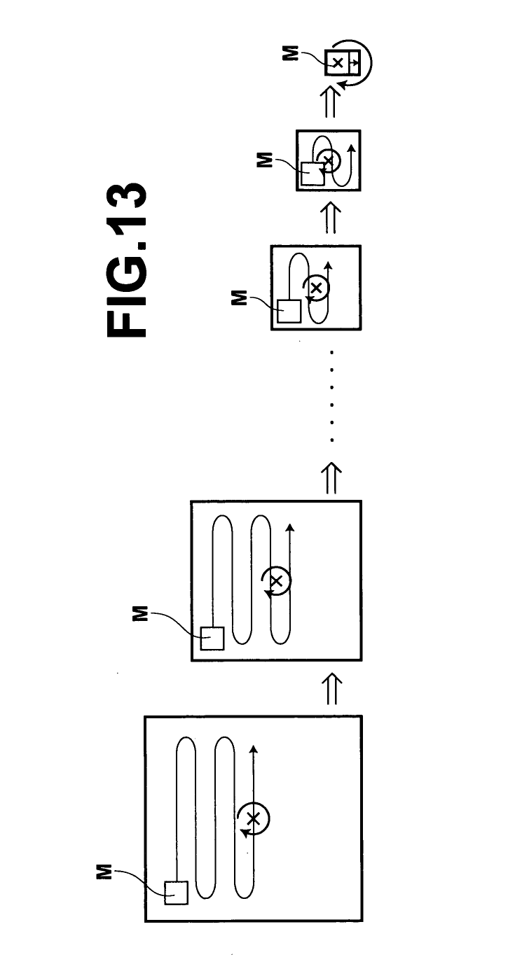

Here, unlike the sample image, which has the size of 30×30 pixels, the photograph image S0 has various sizes. Further, when a face is included in the photograph image S0, the rotation angle of the face on a plane is not always 0 degrees. Therefore, the first distinction unit 5 enlarges or reduces the photograph image S0 in a stepwise manner so that the size of the photograph image in the longitudinal direction or the lateral direction becomes 30 pixels as illustrated in FIG. 13. At the same time, the first distinction unit 5 rotates the photograph image S0 on a plane 360 degrees in a stepwise manner. (FIG. 13 illustrates the reduction state.) A mask M, which has the size of 30×30 pixels, is set on the enlarged or reduced photograph image S0 at each stage of deformation. Further, the mask M is moved pixel by pixel on the enlarged or reduced photograph image S0, and processing is performed to distinguish whether the image in the mask is a facial image. Accordingly, the first distinction unit 5 distinguishes whether the photograph image S0 includes a face.

As the sample images, which were learned during generation of the first reference data E1, the sample images, in which the distance between the centers of both eyes is 9 pixels, 10 pixels or 11 pixels, were used. Therefore, the enlargement rate during enlargement or reduction of the photograph image S0 should be 11/9. Further, the sample images, which were used for learning during generation of the first and second reference data E1 and E2, are sample images, in which a face is rotated on a plane within the range of ±15 degrees. Therefore, the photograph image S0 should be rotated in 30 degree increments in a stepwise manner over 360 degrees.

The characteristic amount calculation unit 2 calculates the characteristic amount C0 at each stage of deformation such as enlargement or reduction of the photograph image S0 and rotation of the photograph image S0.

Then, the first distinction unit 5 distinguishes whether a face is included in the photograph image S0 at all the stages of enlargement or reduction and rotation. If it is judged even once that a face is included in the photograph image S0, the first distinction unit 5 judges that a face is included in the photograph image S0. An area of 30×30 pixels, which corresponds to the position of the mask M at the time when it was distinguished that a face was included in the mask, is extracted as a facial image from the photograph image S0, which has the size and rotation angle at the stage when it was distinguished that a face was included in the image.

The second distinction unit 6 refers to the distinction conditions, which were learned by the second reference data E2 about all of the combinations of the characteristic amount C0 at each pixel, which forms a plurality of kinds of pixel groups in a facial image, which was extracted by the first distinction unit 5. The second distinction unit 6 obtains a distinction point about the combination of the characteristic amount C0 at each pixel, which forms each pixel group. Then, the second distinction unit 6 distinguishes the positions of eyes included in a face by using all of the distinction points. At this time, the direction of the gradient vector K, which is a characteristic amount C0, is quarternarized, and the magnitude of the gradient vector K, which is a characteristic amount C0, is ternarized.

Here, the second distinction unit 6 enlarges or reduces the size of the facial image, which was extracted by the first distinction unit 5, in a stepwise manner. At the same time, the second distinction unit 5 rotates the facial image on a plane 360 degrees in a stepwise manner, and sets a mask M, which has the size of 30×30 pixels, on the enlarged or reduced photograph image S0 at each stage of deformation. Further, the mask M is moved pixel by pixel on the enlarged or reduced facial image, and processing is performed to distinguish the positions of the eyes in the image within the mask.

The sample images, in which the distance between the center positions of both eyes is 9.07 pixels, 10 pixels or 10.3 pixels, were used for learning during generation of the second reference data E2. Therefore, the enlargement rate during enlargement or reduction of the facial image should be 10.3/9.7. Further, the sample images, in which a face is rotated on a plane within the range of ±3 degrees, were used for learning during generation of the second reference data E2. Therefore, the facial image should be rotated in 6 degree increments in a stepwise manner over 360 degrees.

The characteristic amount calculation unit 2 calculates the characteristic amount C0 at each stage of deformation such as enlargement or reduction and the rotation of the facial image.

Further, in the present embodiment, all the distinction points are added at all the stages of deformation of the extracted facial image. Then, coordinates are set in a facial image within the mask M, which has the size of 30×30 pixels, at the stage of deformation when the sum is the largest. The origin of the coordinates is set at the upper left corner of the facial image. Then, positions corresponding to the coordinates (x1, y1) and (x2, y2) of the positions of the eyes in the sample image are obtained. The positions in the photograph image S0 prior to deformation, which correspond to these positions, are distinguished as the positions of the eyes.

If the first distinction unit 5 recognizes that a face is included in the photograph image S0, the first output unit 7 obtains the distance D between both eyes based on the positions Pa and Pb of both eyes, which were distinguished by the second distinction unit 6. Then, the first output unit 7 outputs the positions Pa and Pb of both eyes and the distance D between both eyes to the center-position-of-pupil detection unit 50 as information Q.

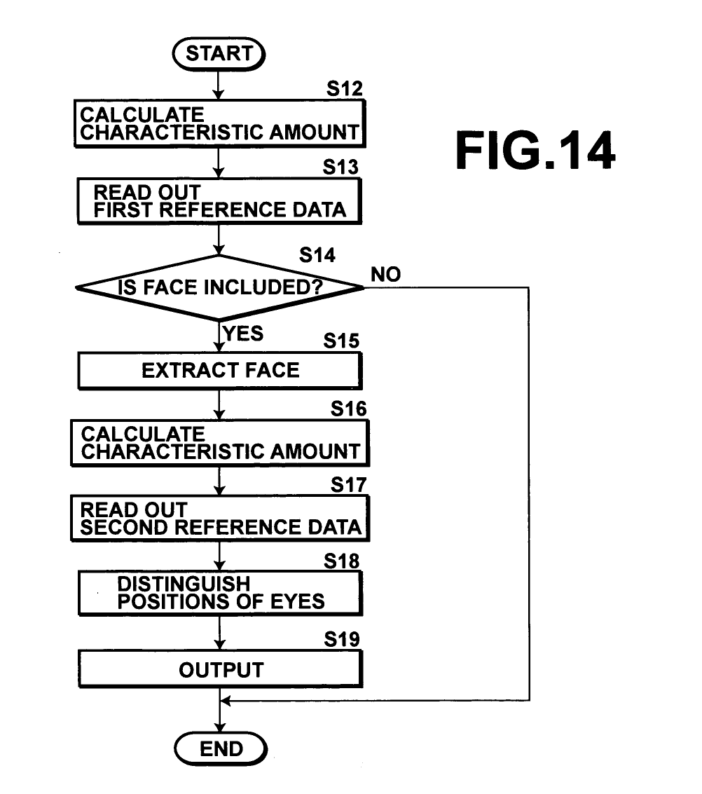

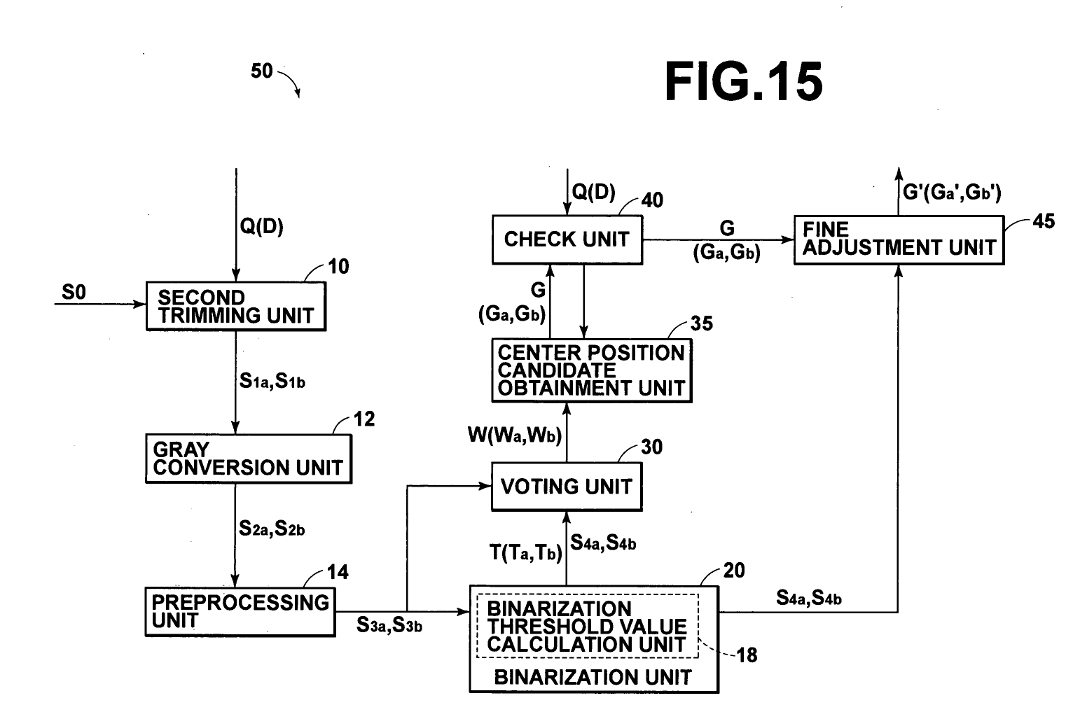

FIG. 14 is a flow chart illustrating an operation of the eye detection unit 1 in the present embodiment. First, the characteristic amount calculation unit 2 calculates the direction and the magnitude of the gradient vector K in the photograph image S0 as the characteristic amount C0 at each stage of enlargement or reduction and rotation of the photograph image S0 (step S12). Then, the first distinction unit 5 reads out the first reference data E1 from the second storage unit 4 (step S13). The first distinction unit 5 distinguishes whether a face is included in the photograph image S0 (step S14).

If the first distinction unit 5 judges that a face is included in the photograph image S0 (step S14: YES), the first distinction unit 5 extracts the face from the photograph image S0 (step S15). Here, the first distinction unit 5 may extract either a single face or a plurality of faces from the photograph image S0. Next, the characteristic amount calculation unit 2 calculates the direction and the magnitude of the gradient vector K of the facial image at each stage of enlargement or reduction and rotation of the facial image (step S16). Then, the second distinction unit 6 reads out the second reference data E2 from the second storage unit 4 (step S17), and performs second distinction processing for distinguishing the positions of the eyes, which are included in the face (step S18).

Then, the first output unit 7 outputs the positions Pa and Pb of the eyes, which are distinguished in the photograph image S0, and the distance D between the centers of both eyes, which is obtained based on the positions Pa and Pb of the eyes, to the center-position-of-pupil detection unit 50 as the information Q (step S19).

Meanwhile, if it is judged that a face is not included in the photograph image S0 in step S14 (step S14: NO), the eye detection unit 1 ends the processing on the photograph image S0.

Next, the center-position-of-pupil detection unit 50 will be described.

FIG. 2 is a block diagram illustrating the configuration of the center-position-of-pupil detection unit 50. As illustrated in the figure, the center-position-of-pupil detection unit 50 includes a second trimming unit 10 for trimming the photograph image S0. (The photograph image S0 is a facial image in this case, but hereinafter called a photograph image.) The second trimming unit 10 performs trimming on the photograph image S0 based on the information Q, which is received from the eye detection unit 1, and obtains trimming images S1a and S1b in the vicinity of the left eye and in the vicinity of the right eye, respectively (hereinafter, S1 is used to represent both S1a and S1b, if it is not necessary to distinguish them in the description). The center-position-of-pupil detection unit 50 also includes a gray conversion unit 12 for performing gray conversion on the trimming image S1 in the vicinity of the eye to obtain a gray scale image S2 (S2a and S2b) of the trimming image S1 in the vicinity of the eye. The center-position-of-pupil detection unit 50 also includes a preprocessing unit 14 for performing preprocessing on the gray scale image S2 to obtain a preprocessed image S3 (S3a and S3b). The center-position-of-pupil detection unit 50 also includes a binarization unit 20, which includes a binarization threshold value calculation unit 18 for calculating a threshold value T for binarizing the preprocessed image S3. The binarization unit 20 binarizes the preprocessed image S3 by using the threshold value T, which is obtained by the binarization threshold value calculation unit 18, and obtains the binary image S4 (S4a and S4b). The center-position-of-pupil detection unit 50 also includes a voting unit 35, which causes the coordinate of each pixel in the binary image S4 to vote in a Hough space for a ring and obtains a vote value at each vote point, which is voted for. The voting unit 35 also calculates a unified vote value W (Wa and Wb) at vote points, which have the same coordinate of the center of a circle. The center-position-of-pupil detection unit 50 also includes a center position candidate obtainment unit 35 for selecting the coordinate of the center of a circle, which corresponds to the largest unified vote value among the unified vote values, which are obtained by the voting unit 35, as a center position candidate G (Ga and Gb). The center position candidate obtainment unit 35 also obtains the next center position candidate if a check unit 40, which will be described later, instructs the center position candidate obtainment unit 35 to search for the next center position candidate. The center-position-of-pupil detection unit 50 also includes the check unit 40 for judging whether the center position candidate, which is obtained by the center position candidate obtainment unit 35, satisfies checking criteria. If the center position candidate satisfies the criteria, the check unit 40 outputs the center position candidate to a fine adjustment unit 45, which will be described later, as the center position of the pupil. If the center position candidate does not satisfy the criteria, the check unit 40 causes the center position candidate obtainment unit 35 to obtain another center position candidate and repeat obtainment of the center position candidate until the center position candidate, which satisfies the checking criteria, is obtained. The center-position-of-pupil detection 50 also includes the fine adjustment unit 45 for obtaining a final center position G′ (G′a and G′b) by performing fine adjustment on the center position G (Ga and Gb) of the pupil, which is output from the check unit 40. The fine adjustment unit 45 obtains the distance D1 between the center positions of the two pupils based on the final center positions. The fine adjustment unit 45 also obtains the middle position Pm between both eyes (the middle position between the center positions of both eyes) based on the center positions Pa and Pb of both eyes, which are included in the information Q.

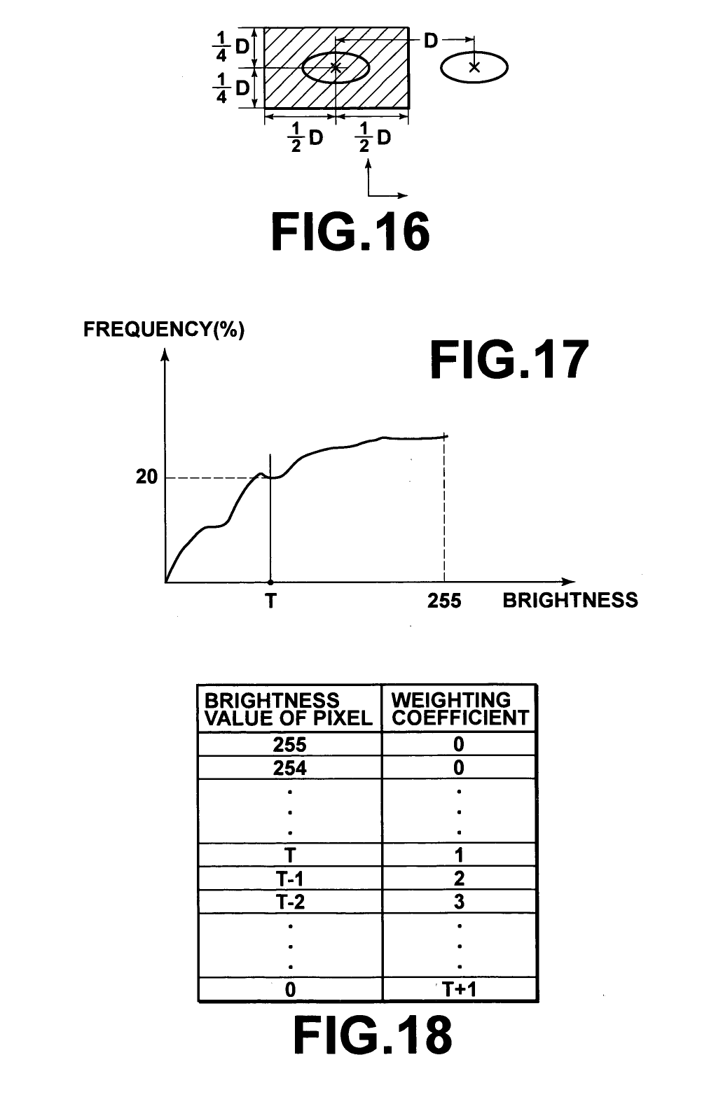

The second trimming unit 10 trims the image to leave predetermined areas, each including only a left eye or a right eye, based on the information Q, which is output from the eye detection unit 1, and obtains the trimming images S1a and S1b in the vicinity of the eyes. Here, the predetermined areas in trimming are the areas, each surrounded by an outer frame, which corresponds to the vicinity of each eye. For example, the predetermined area may be a rectangular area, which has the size of D in the x direction and 0.5 D in the y direction, with its center at the position (center position) of the eye detected by the eye detection unit 1 as illustrated in a shaded area in FIG. 16. The shaded area, which is illustrated in FIG. 16, is the trimming range of the left eye. The trimming range of the right eye may be obtained in a similar manner.

The gray conversion unit 12 performs gray conversion processing on the trimming image S1 in the vicinity of the eye, which is obtained by the second trimming unit 10, according to the following equation (37), and obtains a gray scale image S2.
Y=0.299×R+0.587×G+0.114×B (37)

Note that Y: brightness value
R, G, B: R, G and B values

The preprocessing unit 14 performs preprocessing on the gray scale image S2. Here, smoothing processing and hole-filling processing are performed as the preprocessing. The smoothing processing may be performed by applying a Gaussian filter, for example. The hole-filling processing may be performed as interpolation processing.

As illustrated in FIGS. 3A and 3B, there is a tendency that there is a bright part in the part of a pupil above the center of the pupil in a photograph image. Therefore, the center position of the pupil can be detected more accurately by interpolating data in this part by performing hole-filling processing.

The binarization unit 20 includes the binarization threshold value calculation unit 18. The binarization unit 20 binarizes the preprocessed image S3, which is obtained by the preprocessing unit 14, by using the threshold value T, which is calculated by the binarization threshold value calculation unit 18, and obtains a binary image S4. Specifically, the binarization threshold value calculation unit 18 generates a histogram of the brightness about the preprocessed image S3, which is illustrated in FIG. 17. The binarization threshold value calculation unit 18 obtains a brightness value corresponding to the frequency of occurrence, which is a fraction of the total number (⅕ or 20% in FIG. 17) of pixels in the preprocessed image S3, as the threshold value T for binarization. The binarization unit 20 binarizes the preprocessed image S3 by using the threshold value T, and obtains the binary image S4.

The voting unit 30 causes the coordinate of each pixel (pixel, of which the pixel value is 1) in the binary image S4 to vote for a point in the Hough space for a ring (X coordinate of the center of the circle, Y coordinate of the center of the circle, and a radius r), and calculates a vote value at each vote point. Normally, if a pixel votes for a single vote point, the vote value is increased by 1 by judging that the vote point is voted for once. Accordingly, a vote value at each vote point is obtained. Here, when a pixel votes for a vote point, the vote value is not increased by 1. The voting unit 30 refers to the brightness value of the pixel, which has voted. If the brightness value is smaller, the voting unit 30 adds a larger weight to a value, which is added to the vote value, and obtains the vote value by adding the value. FIG. 18 is a weighting coefficient table, which is used by the voting unit 30 in the center-position-of-pupil detection device in the present embodiment, which is illustrated in FIG. 1. In FIG. 18, T denotes a threshold value T for binarization, which is calculated by the binarization threshold value calculation unit 18.

After the voting unit 30 obtains the vote value at each vote point as described above, the voting unit 30 adds the vote value at each of the vote points, of which coordinate value of the center of a ring, namely the (X, Y) coordinate value in the Hough space for a ring (X, Y, r), is the same. Accordingly, the voting unit 30 obtains a unified voting value W, which corresponds to each (X, Y) coordinate value. The voting unit 30 outputs the obtained unified vote value W to the center position candidate obtainment unit 35 by correlating the unified vote value W with the corresponding (X, Y) coordinate value.

The center position candidate obtainment unit 35 obtains an (X, Y) coordinate value, which corresponds to the largest unified vote value, as the center-position-of-pupil candidate G, based on each unified vote value, which is received from the voting unit 30. The center position candidate obtainment unit 35 outputs the obtained coordinate value to the check unit 40. Here, the center position candidate G, which is obtained by the center position obtainment unit 35, is the center position Ga of the left pupil and the center position Gb of the right pupil. The check unit 40 checks the two center positions Ga and Gb based on the distance D between both eyes, which is output from the eye detection unit 1.

Specifically, the check unit 40 checks the two center positions Ga and Gb based on the following two checking criteria.
1. The difference in the Y coordinate value between the center position of the left pupil and the center position of the right pupil is not larger than D/50.
2. The difference in the X coordinate value between the center position of the left pupil and the center position of the right pupil is within the range from 0.8×D to 1.2×D.

The check unit 40 judges whether the center position candidates Ga and Gb of the two pupils, which are received from the center position candidate obtainment 35, satisfy the two checking criteria as described above. If the two criteria are satisfied (hereinafter called “satisfying the checking criteria”), the check unit 40 outputs the center position candidates Ga and Gb to the fine adjustment unit 45 as the center positions of the pupils. In contrast, if two criteria or one of the two criteria are not satisfied (hereinafter called “not satisfying the checking criteria”), the check unit 40 instructs the center position candidate obtainment unit 35 to obtain the next center position candidate. The check unit 40 also performs checking on the next center position candidate, which is obtained by the center position candidate obtainment unit 35, as described above. If the checking criteria are satisfied, the check unit 40 outputs the center positions. If the checking criteria are not satisfied, the check unit 40 performs processing such as instructing the center position candidate obtainment unit 35 to obtain a center position candidate again. The processing is repeated until the checking criteria are satisfied.

Meanwhile, if the check unit 40 instructs the center position candidate obtainment unit 35 to obtain the next center position candidate, the center position candidate obtainment unit 35 fixes the center position of an eye (left pupil in this case) first, and obtains the (X, Y) coordinate value of a vote point, which satisfies the following three conditions, as the next center position candidate based on each unified vote value Wb of the other eye (right pupil in this case).
1. The coordinate value is away from the position represented by the (X, Y) coordinate value of the center position candidate, which was output to the check unit 40 last time, by D/30 or more (D: distance between the centers of both eyes).
2. A corresponding unified vote value is the next largest unified vote value to a unified vote value, which corresponds to the (X, Y) coordinate value of the center position candidate, which was output to the check unit 40 last time, among the unified vote values, which correspond to the (X, Y) coordinate values, which satisfy condition 1.
3. The corresponding unified vote value is equal to or larger than 10% of the unified vote value (the largest unified vote value), which corresponds to the coordinate value (X, Y) of the center position candidate, which was output to the check unit 40 at the first time.

The center position candidate obtainment unit 35 fixes the center position of a left pupil and searches for the center position candidate of a right pupil, which satisfies the three conditions as described above, based on a unified vote value Wb, which has been obtained about the right pupil. If the center position candidate obtainment unit 35 does not find any candidate that satisfies the three conditions as described above, the center position candidate obtainment unit 35 fixes the center position of the right pupil and searches for the center position of the left pupil, which satisfies the three conditions as described above based on the unified vote value Wa, which has been obtained about the left pupil.

The fine adjustment unit 45 performs fine adjustment on the center position G of the pupil (the center position candidate, which satisfies the checking criteria), which is output from the check unit 40. First, fine adjustment of the center position of the left pupil will be described. The fine adjustment unit 45 performs a mask operation on a binary image S4a of a vicinity-of-eye trimming image S2a of a left eye three times, which is obtained by the binarization unit 20. The fine adjustment unit 45 uses a mask of all 1's, which has the size of 9×9. The fine adjustment unit 45 performs fine adjustment on the center position Ga of the left pupil, which is output from the check unit 40, based on the position (called Gm) of the pixel, which has the maximum result value obtained by the mask operation. Specifically, an average position of the position Gm and the center position Ga may be used as the final center position G′a of the pupil, for example. Alternatively, an average position, obtained by weighting the center position Ga and performing an average operation, may be used as the final center position G′a of the pupil. Here, it is assumed that the center position Ga is weighted to perform the average operation.

Fine adjustment of the center position of the right pupil is performed by using a binary image S4b of a vicinity-of-eye trimming image S1b of a right eye in the same manner as described above.

The fine adjustment unit 45 performs fine adjustment on the center positions Ga and Gb of the pupils, which are output from the check unit 40, and obtains the final center positions G′a and G′b. Then, the fine adjustment unit 45 obtains the distance D1 between the two pupils by using the final center positions G′. The fine adjustment unit 4 also obtains the middle position Pm between both eyes based on the center positions Pa and Pb of both eyes, which are included in the information Q. Then, the fine adjustment unit 45 outputs the distance D1 and the middle position Pm to the trimming area obtainment unit 60a.

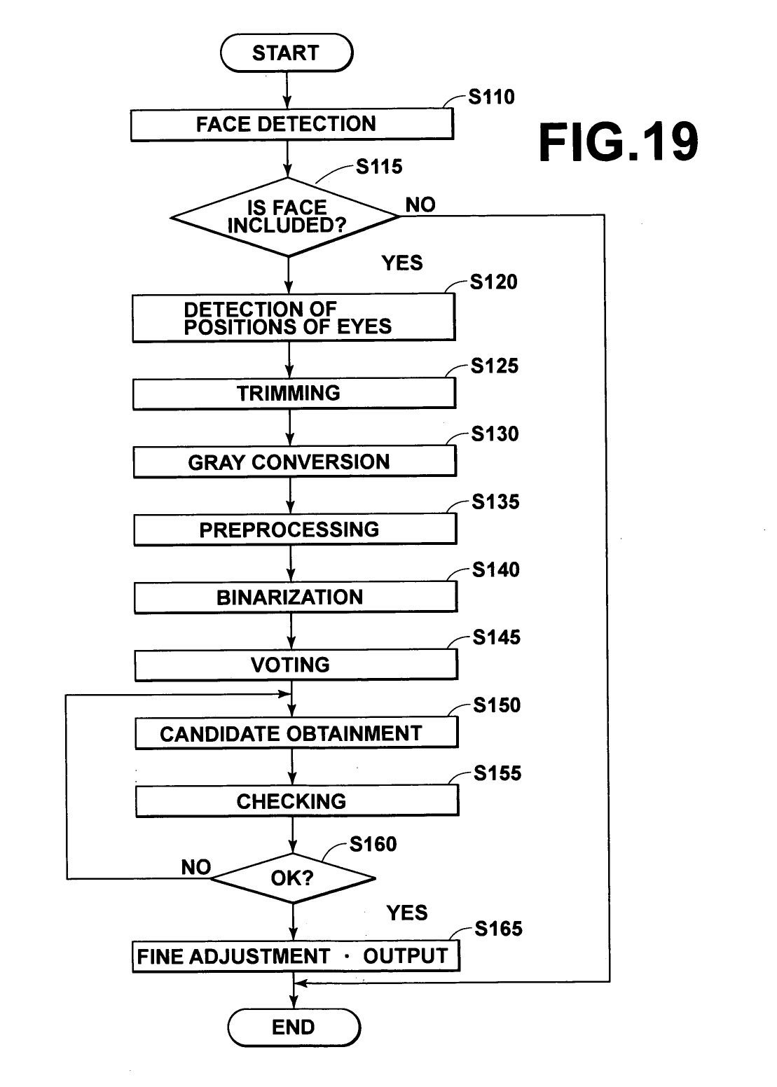

FIG. 19 is a flow chart illustrating processing at the eye detection unit 1 and the center-position-of-pupil detection unit 50 in the image processing system A in the embodiment illustrated in FIG. 1. As illustrated in FIG. 19, the eye detection unit 1 distinguishes whether a face is included in a photograph image S0, first (step S110). If it is distinguished that a face is not included in the photograph image S0 (step S115: NO), processing on the photograph image S0 ends. If it is distinguished that a face is included in the photograph image S0 (step S115: YES), the eye detection unit 1 further detects the positions of the eyes in the photograph image S0. The eye detection unit 1 outputs the positions of both eyes and the distance D between the centers of both eyes as information Q to the second trimming unit 10 (step S120). The second trimming unit 10 performs trimming on the photograph image S0 to obtain a vicinity-of-eye trimming image S1a, which includes only the left eye, and a vicinity-of-eye trimming image S1b, which includes only the right eye (step S125). The gray conversion unit 12 performs gray conversion on the vicinity-of-eye trimming image S1 to convert the vicinity-of-eye trimming image S1 to a gray scale image S2 (step S130). Then, the preprocessing unit 14 performs smoothing processing and hole-filling processing on the gray scale image S2. Further, the binarization unit 20 performs binarization processing on the gray scale image S2 to convert the gray scale image S2 into a binary image S4 (steps S135 and S140). The voting unit 30 causes the coordinate of each pixel in the binary image S4 to vote in the Hough space for a ring. Consequently, a unified vote value W is obtained, which corresponds to the (X, Y) coordinate value representing the center of each circle (step S145). First, the center position candidate obtainment unit 35 outputs the (X, Y) coordinate value, which corresponds to the largest unified vote value, to the check unit 40 as the center-position-of-pupil candidate G (step S150) The check unit 40 checks the two center position candidates Ga and Gb, which are output from the center position candidate obtainment unit 35, based on checking criteria as describe above (step S115). If the two center position candidates Ga and Gb satisfy the checking criteria (step S160: YES), the check unit 40 outputs the two center position candidates Ga and Gb to the fine adjustment unit 45 as the center positions. If the two center position candidates Ga and Gb do not satisfy the checking criteria (step S160: NO), the check unit 40 instructs the center position candidate obtainment unit 35 to search for the next center position candidate (step S150). The check unit 40 repeats the processing from step S150 to step S160 until the check unit 40 distinguishes that the center position candidate G, which is output from the center position candidate obtainment unit 35, satisfies the checking criteria.

The fine adjustment unit 45 performs fine adjustment on the center position G, which is output by the check unit 40. The fine adjustment unit 45 obtains the distance D1 between the two pupils based on the final center positions G′. The fine adjustment unit 45 also obtains the middle position Pm between both eyes based on the center positions Pa and Pb of both eyes, which are included in the information Q. Then, the fine adjustment unit 45 outputs the distance D1 and the middle position Pm to the trimming area obtainment unit 60a (step S165).

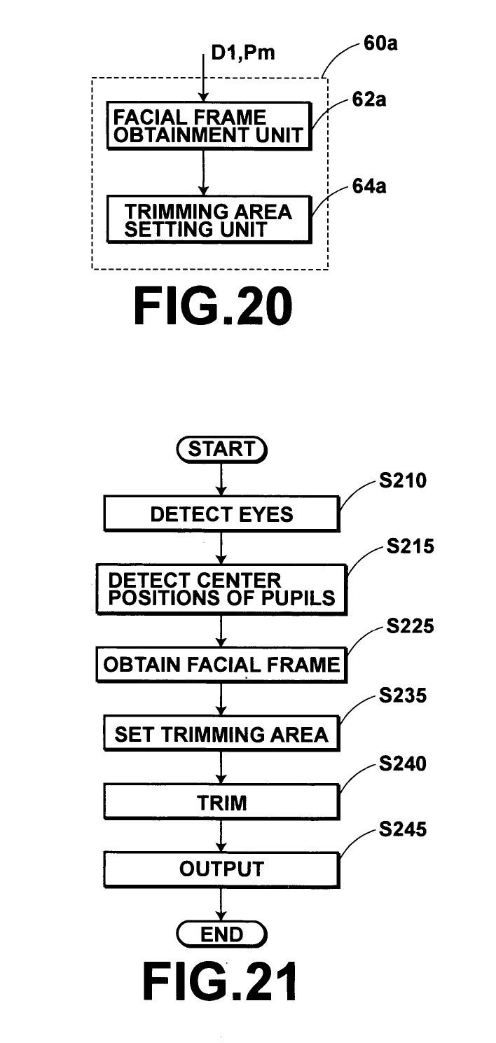

FIG. 20 is a block diagram illustrating the configuration of the trimming area obtainment unit 60a. As illustrated in FIG. 20, the trimming area obtainment unit 60a includes a facial frame obtainment unit 62a and a trimming area setting unit 64a. The facial frame obtainment unit 62a obtains values L1a, L1b and L1c by performing operations according to equations (38) by using the distance D1 between both pupils in a facial photograph image S0, the middle position Pm between both eyes and coefficients U1a, U1b and U1c. Then, the facial frame obtainment unit 62a obtains a facial frame by using each of values L1a, L1b and L1c as the lateral width of the facial frame with its middle in the lateral direction at the middle position Pm between both eyes in the facial photograph image S0, the distance from the middle position Pm to the upper side of the facial frame, and the distance from the middle position Pm to the lower side of the facial frame, respectively. The coefficients U1a, U1b and U1c are stored in the first storage unit 68a. In the present embodiment, the coefficients are 3.250, 1.905 and 2.170, respectively.

The trimming area setting unit 64a sets a trimming area in the facial photograph image S0 based on the position and the size of the facial frame, which is obtained by the facial frame obtainment unit 62a, so that the trimming image satisfies a predetermined output format at the output unit 80.
L1a=D1×U1a
L1b=D1×U1b (38)
L1c=D1×U1c
U1a=3.250
U1b=1.905
U1c=2.170

FIG. 21 is a flow chart illustrating processing in the image processing system A according to the first embodiment of the present invention, which is illustrated in FIG. 1. As illustrated in FIG. 21, in the image processing system A according to the present embodiment, first, the eye detection unit 1 detects the positions of both eyes (the center position of each of both eyes) in an image S0, which is a facial photograph image. The eye detection unit 1 obtains information Q, which includes the positions of both eyes and the distance D between the centers of both eyes (step S210). The center-position-of-pupil detection unit 50 detects the center positions G′a and G′b of the pupils in both eyes based on the information Q, which is received from the eye detection unit 1, and obtains the distance D1 between the two pupils and the middle position Pm between both eyes (step S215). In the trimming area obtainment unit 60a, first, the facial frame obtainment unit 62a calculates the position and the size of a facial frame in the facial photograph image S0 according to the equations (38) as described above by using the middle position Pm between both eyes, the distance D1 between the pupils and the coefficients U1a, U1b and U1c, which are stored in the first storage unit 68a (step S225). Then, the trimming area setting unit 64a in the trimming area obtainment unit 60a sets a trimming area based on the position and the size of the facial frame, which are obtained by the facial frame obtainment unit 62a (step S235). The first trimming unit 70 performs trimming on the facial photograph image S0 based on the trimming area, which is set by the trimming area obtainment unit 60a, and obtains a trimming image S5 (step S240). The output unit 80 prints out the trimming image S5 and obtains an identification photograph (step S245).

As described above, in the image processing system A according to the present embodiment, the positions of both eyes and the center positions of the pupils are detected in the facial photograph image S0. Then, the facial frame is obtained based on the middle position Pm between both eyes and the distance D1 between the pupils, and a trimming area is set based on the obtained facial frame. The trimming area can be set if the middle position between both eyes and the distance between the pupils are known. Therefore, processing is facilitated.

Further, in the image processing system A according to the present embodiment, the positions of the eyes or pupils are automatically detected. However, an operator may indicate the center positions of the eyes or the pupils. The facial frame may be obtained based on the positions, which are indicated by the operator, and the distance between both eyes, which is calculated based on the indicated positions.

FIG. 22 is a block diagram illustrating the configuration of an image processing system B according a second embodiment of the present invention. The elements in the image processing system B except a trimming area obtainment unit 60b and a third storage unit 68b are the same as the corresponding elements in the image processing system A, which is illustrated in FIG. 1. Therefore, only the trimming area obtainment unit 60b and the third storage unit 68b will be described. The same reference numerals as the corresponding elements in the image processing system A, which is illustrated in FIG. 1, are assigned to the other elements in the image processing system B.

The third storage unit 68b stores data, which is required by the first trimming unit 70, in the same manner as the first storage unit 68a in the image processing system A, which is illustrated in FIG. 1. The third storage unit 68b also stores coefficients U2a, U2b and U2c, which are required by the trimming area obtainment unit 60b. The coefficients U2a, U2b and U2c will be described later. In the present embodiment, the values of 3.250, 1.525 and 0.187 are used as the examples of the coefficients U2a, U2b and U2c, which are stored in the third storage unit 68b.

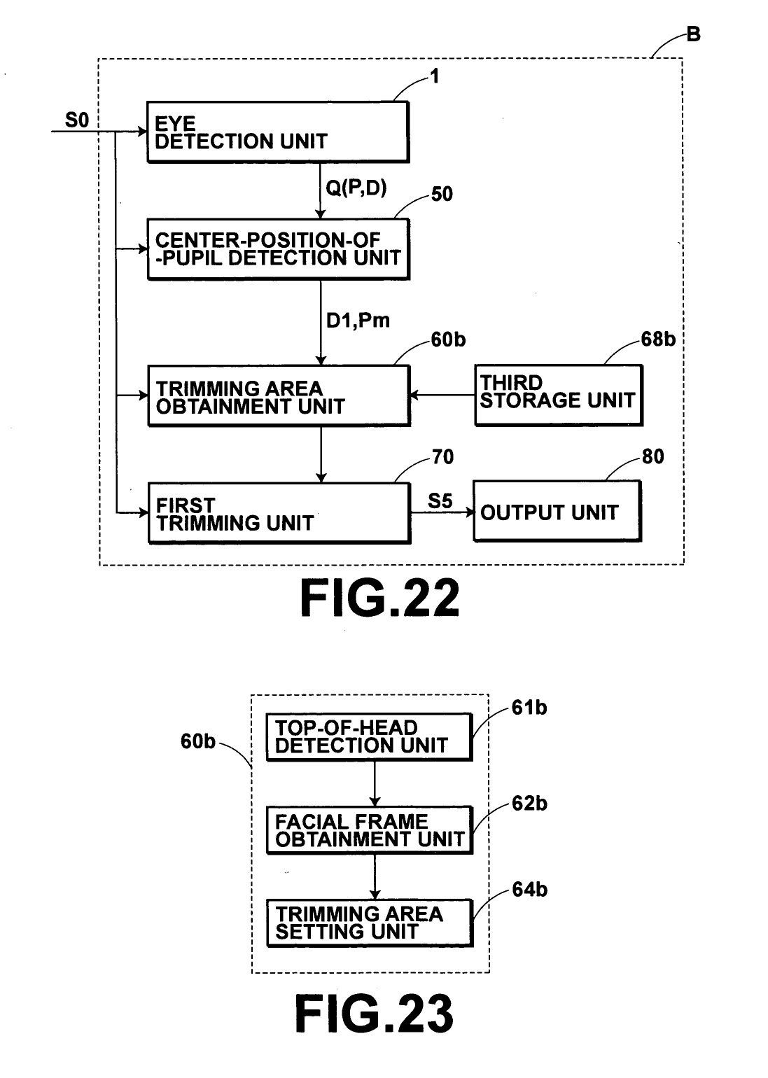

FIG. 23 is a block diagram illustrating the configuration of the trimming area obtainment unit 60b. As illustrated in FIG. 23, the trimming area obtainment unit 60b includes a top-of-head detection unit 61b, a facial frame obtainment unit 62b and a trimming area setting unit 64b.

The top-of-head detection unit 61b performs processing for detecting the top of a head on the part of a face above the pupils, and detects the position of the top of the head in the image S0, which is a facial photograph image. The top-of-head detection unit 61b also calculates the perpendicular distance H from the detected top of the head position to the middle position Pm between both eyes, which is calculated by the center-position-of-pupil detection unit 50. For detecting the position of the top of the head, the method disclosed in U.S. Patent Laid-Open No. 20020085771 may be used, for example.

The facial frame obtainment unit 62b obtains values L2a and L2c according to the expressions (39) by using the distance D1 between both pupils and the middle position Pm between both eyes in the facial photograph image, which are obtained by the center-position-of-pupil detection unit 50, the perpendicular distance H, which is obtained by the top-of-head detection unit 61b, and the coefficients U2a, U2b and U2c, which are stored in the third storage unit 68b. Then, the facial frame obtainment unit 62b obtains a facial frame by using each of values L2a and L2c as the lateral width of the facial frame with its middle in the lateral direction at the middle position Pm between both eyes in the facial photograph image S0 and the distance from the middle position Pm to the lower side of the facial frame, respectively, and using the perpendicular distance H as the distance from the middle position Pm to the upper side of the facial frame.
L2a=D1×U2a
L2c=D1×U2b+H×U2c (39)
U2a=3.250
U2b=1.525
U2c=0.187

The trimming area setting unit 64b sets a trimming area in the facial photograph image S0 based on the position and the size of the facial frame, which are obtained by the facial frame obtainment unit 62b, so that the trimming image satisfies an output format at the output unit 80.

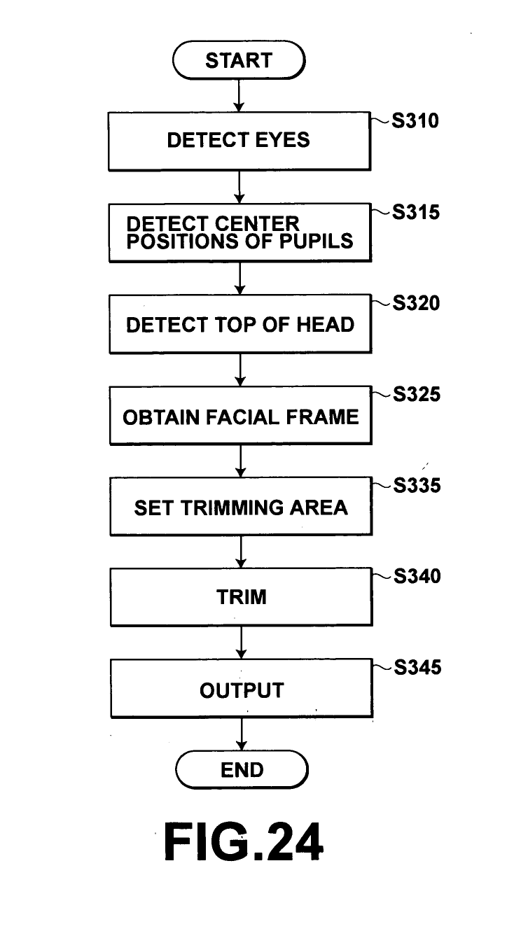

FIG. 24 is a flow chart illustrating processing in the image processing system B, which is illustrated in FIG. 22. As illustrated in FIG. 24, in the image processing system B according to the present embodiment, first, the eye detection unit 1 detects the positions of both eyes in the image S0, which is a facial photograph image. Then, the eye detection unit 1 obtains information Q, which includes the positions of both eyes and the distance D between the centers of both eyes (step S310). Then, the center-position-of-pupil detection unit 50 detects the center positions G′a and G′b of the pupils in both eyes based on the information Q, which is received from the eye detection unit 1. The center-position-of-pupil detection unit 50 also obtains the distance D1 between the two pupils and the middle distance Pm between both eyes (step S315). In the trimming area obtainment unit 60b, the top-of-head detection unit 61b detects the position of the top of the head in the facial photograph image S0, first. The top-of-head detection unit 61b also calculates the perpendicular distance H from the detected position of the top of the head to the middle position Pm between both eyes (step S320). Then, the facial frame obtainment unit 62b calculates the position and the size of the facial frame in the facial photograph image S0 according to the expressions (39), which are described above, by using the middle position Pm between both eyes, the distance D1 between the pupils, the perpendicular distance H and the coefficients, which are stored in the third storage unit 68b (step S325). The trimming area setting unit 64b in the trimming area obtainment unit 60b sets a trimming area based on the position and the size of the facial frame, which are obtained by the facial frame obtainment unit 60b (step S335). The first trimming unit 70 performs trimming on the facial photograph image S0 based on the trimming area, which is set by the trimming area obtainment unit 60b, and obtains a trimming image S5 (step S340). The output unit 80 produces an identification photograph by printing out the trimming image S5 (step S345).

As described above, in the image processing system B according to the present embodiment, first, the center positions of both eyes and the center positions of the pupils in the facial photograph image S0 are detected. Then, the middle position between both eyes and the distance between the pupils are obtained. The position of the top of the head is detected from the part of a face above the pupils and the perpendicular distance from the top of the head to the eyes is calculated. Then, the position and the size of the facial frame are calculated based on the middle position between both eyes, the distance between the pupils, the position of the top of the head, and the perpendicular distance from the top of the head to the pupils. A trimming area is set based on the position and the size of the facial frame, which are calculated. Accordingly, the trimming area can be set by performing simple processing as the processing in the image processing system A according to the embodiment illustrated in FIG. 1. Further, since the position and the size of the facial frame are calculated based on the position of the top of the head and the perpendicular distance from the top of the head to the eyes in addition to the distance between the pupils, the facial frame can be determined more accurately. Further, the trimming area can be set more accurately.

Further, since the position of the top of the head is detected from the part of the face above the position of the eyes (pupils, in this case), the position of the top of the head can be detected more quickly and accurately than the method of detecting the position of the top of the head from the whole facial photograph image.

In the image processing system B according to the present embodiment, the facial frame obtainment unit 62b obtains the values L2a and L2c according to the expressions (39) as described above by using the distance D1 between both pupils, the perpendicular distance H, which is detected by the top-of-head detection unit 61b and the coefficients U2a, U2b and U2c. The facial frame obtainment unit 62b obtains a facial frame by using each of values L2a and L2c as the lateral width of the facial frame with its middle in the lateral direction at the middle position Pm between both eyes in the facial photograph image S0 and the distance from the middle position Pm to the lower side of the facial frame, respectively, and using the perpendicular distance H as the distance from the middle position Pm to the upper side of the facial frame. However, the distance from the middle position Pm to the lower side of the facial frame may be calculated based only on the perpendicular distance H. Specifically, The facial frame obtainment unit 62b may calculate the lateral width (L2a) of the facial frame with its middle in the lateral direction at the middle position Pm between both pupils according to the following equations (40) by using the distance D1 between both pupils and the coefficient U2a. The facial frame obtainment unit 62b may also calculate the distance (L2c) from the middle position Pm to the lower side of the facial frame by using the perpendicular distance H and the coefficient U2c.
L2a=D1×U2a
L2c=H×U2c (40)
U2a=3.250
U2c=0.900

Further, in the image processing system B according to the present embodiment, the positions of the eyes or the pupils and the position of the top of the head are automatically detected. However, an operator may indicate the center positions of the eyes or the pupils, and the position of the top of the head may be detected from the part of the face above the indicated positions.

In the image processing system A and the image processing system B according to the embodiments as described above, a value, which may also be applied to the case of strict output conditions such as passports, is used as each of the coefficients U1a, U1b, . . . U2c, etc. for setting the facial frame. However, in the case of identification photographs for company identification cards, resumes, or the like, the output conditions are not so strict. In the case of Purikura or the like, the output conditions require only the inclusion of a face. In these cases, each coefficient value may be within the range of (1±0.05) times of each of the above-mentioned values. Further, each of the coefficient values is not limited to the above-mentioned values.

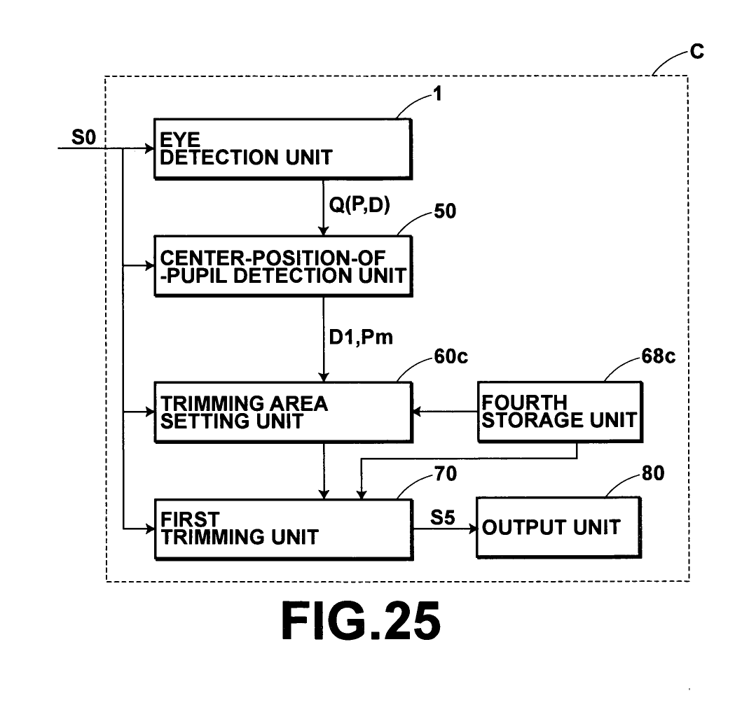

FIG. 25 is a block diagram illustrating the configuration of an image processing system C according to a third embodiment of the present invention. The elements in the image processing system C, except for a trimming area setting unit 60c and a fourth storage unit 68c, are the same as the corresponding elements in the image processing system A and the image processing system B as described above. Therefore, only the trimming area setting unit 60c and the fourth storage unit 68c will be described. The same reference numerals as the corresponding elements in the image processing system A and the image processing system B described above are assigned to the other elements in the image processing system C.

The fourth storage unit 68c stores data, which is required by the first trimming unit 70, in the same manner as the first storage unit 68a and the third storage unit 68b in the image processing system A and the image processing system B described above. The fourth storage unit 68c also stores coefficients U1a, U1b and U1c, which are required by the trimming area setting unit 60c. The coefficients U1a, U1b and U1c will be described later. In the present embodiment, the values of 5.04, 3.01, and 3.47 are used as the examples of the coefficients U1a, U1b, and U1c, which are stored in the third storage unit 68c.

The trimming area setting unit 60c obtains values L1a, L1b and L1c by performing operations according the equations (41) using the distance D1 between both pupils in a facial photograph image, which is obtained by the center-position-of-pupil detection unit 50, the center position Pm between both eyes, and coefficients U1a, U1b and U1c, which are stored in the fourth storage unit 68c. Then, the trimming area setting unit 60c sets a trimming area by using each of the values L1a, L1b and L1c as the lateral width of the trimming area with its middle in the lateral direction at the middle position Pm between both eyes in the facial photograph image S0, the distance from the middle position Pm to the upper side of the trimming area, and the distance from the middle position Pm to the lower side of the trimming area, respectively.
L1a=D1×U1a
L1b=D1×U1b (41)
L1c=D1×U1c
U1a=5.04
U1b=3.01
U1c=3.47

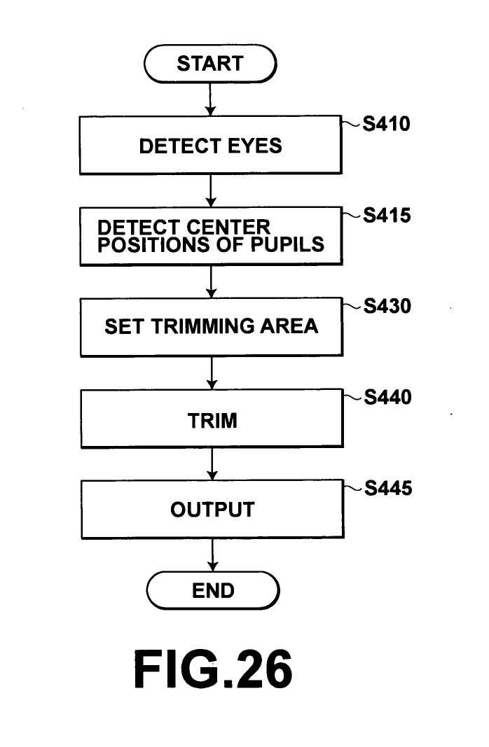

FIG. 26 is a flow chart illustrating processing in the image processing system C, which is illustrated in FIG. 25. As illustrated in FIG. 26, in the image processing system C according to the present embodiment, first, the eye detection unit 1 detects the positions of both eyes in an image S0, which is a facial photograph image. Then, the eye detection unit 1 obtains information Q, which includes the positions of both eyes and the distance D between the centers of both eyes (step S410). The center-position-of-pupil detection unit 50 detects the center positions G′a and G′b of the pupils in both eyes based on the information Q, which is received from the eye detection unit 1. The center-position-of-pupil detection unit 50 also obtains the middle position Pm between both eyes (step S415). The trimming area setting unit 60c sets a trimming area according to the equations (41) as described above by using the middle position Pm between both eyes, the distance D1 between the pupils and the coefficients U1a, U1b and U1c, which are stored in the fourth storage unit 68c (step S430). The first trimming unit 70 performs trimming on the facial photograph image S0 based on the trimming area, which is set by the trimming area setting unit 60c, and obtains a trimming image S5 (step S440). The output unit 80 produces an identification photograph by printing out the trimming image S5 (step S445).

As described above, in the image processing system C according to the present embodiment, the trimming area can be set if the positions of the eyes (pupils in this case) and the distance between the eyes are known as in the image processing system A, which is illustrated in FIG. 1. Therefore, trimming area is set directly without calculating the position and the size of the facial frame. Accordingly, processing can be performed at an even higher speed.

Needless to say, the operator may indicate the positions of the eyes as in the cases of image processing system A and the image processing system B.

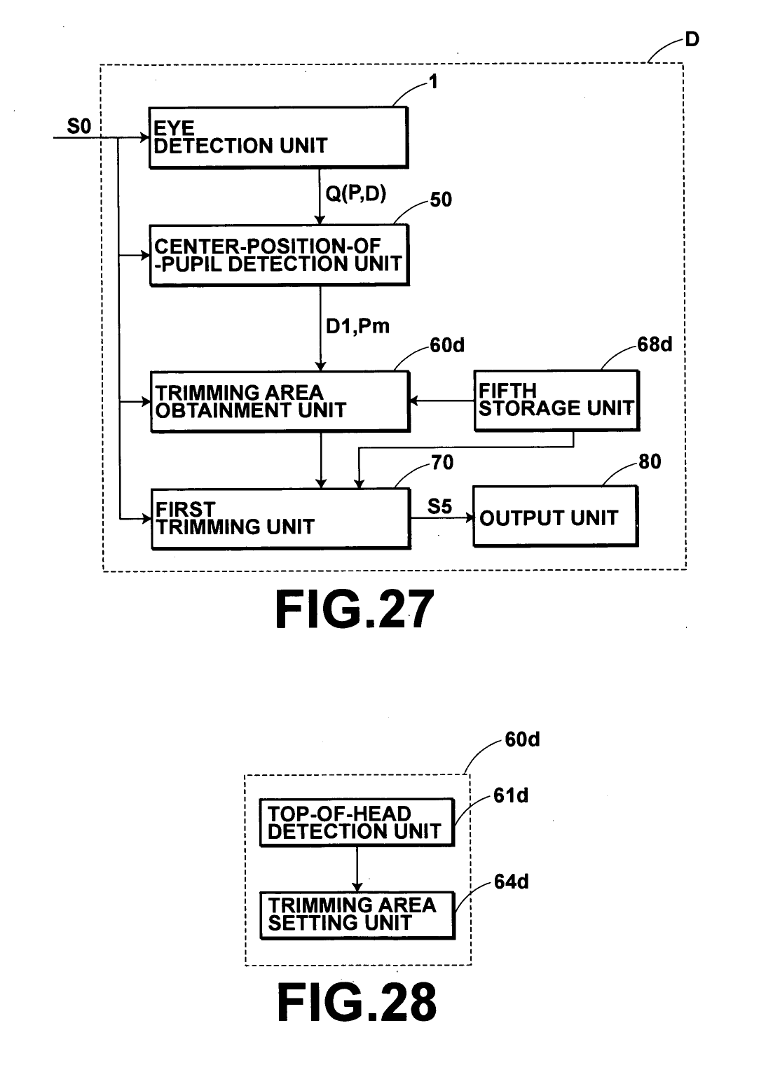

FIG. 27 is a block diagram illustrating the configuration of an image processing system D according to a fourth embodiment of the present invention. The elements in the image processing system C, except for a trimming area obtainment unit 60d and a fifth storage unit 68d, are the same as the corresponding elements in the image processing system according to each of embodiments as describe above. Therefore, only the trimming area obtainment unit 60d and the fifth storage unit 68d will be described. The same reference numerals as the corresponding elements in the image processing system in each of the embodiments as described above are assigned to the other elements.

The fifth storage unit 68d stores data (such as output format at the output unit 80), which is required by the first trimming unit 70. The fifth storage unit 68d also stores coefficients U2a, U2b1, U2c1, U2b2, and U2c2, which are required by the trimming area obtainment unit 60d. In the present embodiment, the values of 5.04, 2.674, 0.4074, 0.4926, and 1.259 are used as the examples of the coefficients U2a, U2b1, U2c1, U2b2, and U2c2.

FIG. 28 is a block diagram illustrating the configuration of the trimming area obtainment unit 60d. As illustrated in FIG. 28, the trimming area obtainment unit 60d includes a top-of-head detection unit 61d and a trimming area setting unit 64d.

The top-of-head detection unit 61d detects the position of the top of the head in an image S0, which is a facial photograph image, from the part of a face above the pupils. The top-of-head detection unit 61d also calculates the perpendicular distance H based on the detected position of the top of the head and the middle position Pm between both eyes, which is calculated by the center-position-of-pupil detection unit 50.

The trimming area setting unit 64d obtains values L2a, L2b and L2c by performing operations according to the equations (42) by using the distance D1 between both pupils in the facial photograph image S0, the perpendicular distance H from the pupils to the top of the head, which is detected by the top-of-head detection unit 61b, and coefficients U2a, U2b1, U2c1, U2b2 and U2c2. The trimming area setting unit 64d sets a trimming area by using each of values L2a, L2b and L2c as the lateral width of the trimming area with its middle in the lateral direction at the middle position Pm between both eyes in the facial photograph image S0, the distance from the middle position Pm to the upper side of the trimming area, and the distance from the middle position Pm to the lower side of the trimming area, respectively.
L2a=D1×U2a
L2b=D1×U2b1+H×U2c1 (42)
L2c=D1×U2b2+H×U2c2
U2a=5.04
U2b1=2.674
U2c1=0.4074
U2b2=0.4926
U2c2=1.259

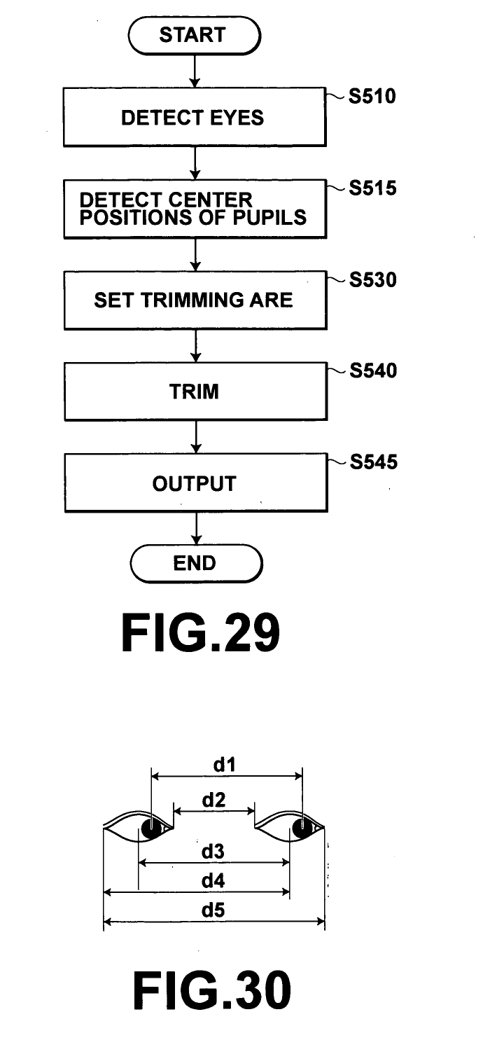

FIG. 29 is a flow chart illustrating processing in the image processing system D, which is illustrated in FIG. 27. As illustrated in FIG. 29, in the image processing system D according to the present embodiment, first, the eye detection unit 1 detects the positions of both eyes in an image S0, which is a facial photograph image. Then, the eye detection unit 1 obtains information Q, which includes the positions of both eyes and the distance D between the centers of both eyes (step S510). The center-position-of-pupil detection unit 50 detects the center positions G′a and G′b of the pupils in both eyes based on the information Q, which is received from the eye detection unit 1, and obtains the distance D1 between the two pupils. The center-position-of-pupil detection unit 50 also obtains the middle position Pm between both eyes (step S515). The trimming area obtainment unit 60d sets a trimming area according to the equations (42) as described above by using the middle position Pm between both eyes, the distance D1 between the pupils and coefficients U2a, U2b1, U2c1, U2b2 and U2c2, which are stored in the fifth storage unit 68d (step S530). The first trimming unit 70 performs trimming on the facial photograph image S0 based on the trimming area, which is obtained by the trimming area obtainment unit 60d, and obtains a trimming image S5 (step S540). The output unit 80 produces an identification photograph by printing out the trimming image S5 (step S545).

In the image processing system D according to the present embodiment, the trimming area obtainment unit 60d obtains values L2a, L2b and L2c by performing operation according to the equations (42) as described above by using the distance D1 between both pupils, the perpendicular distance H, which is detected by the top-of-head detection unit 61b, and coefficients U2a, U2b1, U2c1, U2b2, and U2c2. The trimming area obtainment unit 60d sets a trimming area by using each of values L2a, L2b and L2c as the lateral width of the trimming area with its middle in the lateral direction at the middle position Pm between both eyes in the facial photograph image S0, the distance from the middle position Pm to the upper side of the trimming area, and the distance from the middle position Pm to the lower side of the trimming area, respectively. However, the distance from the middle position Pm to the upper side of the trimming area and the distance from the middle position Pm to the lower side of the trimming area may also be calculated based only on the perpendicular distance H. Specifically, the trimming area obtainment unit 60d may calculate the lateral width (L2a) of the trimming area with its middle in the lateral direction at the middle position Pm between both eyes according to the following equations (43) by using the distance D1 between both pupils and the coefficient U2a. The trimming area obtainment unit 60d may calculate the distance (L2c) from the middle position Pm to the lower side of the trimming area according to the equations (43) by using the perpendicular distance H and the coefficient U2c.
L2a=D1×U2a
L2b=H×U2b (43)
L2c=H×U2c
U2a=5.04
U2b=1.495
U2c=1.89

So far, for the purpose of simplifying the explanation on the main features of the present invention, the image processing system for obtaining an identification photograph by performing trimming on an input facial photograph image has been explained as the embodiments. However, in addition to the image processing systems in the embodiments as described above, the present invention may be applied to an apparatus, which performs processing from capturing a facial photograph image to obtaining a print of the photograph or a trimming image, such as a photography box apparatus, which has the function of the image processing system in each of the embodiments as described above, for example. The present invention may also be applied to a digital camera or the like, which has a function of the image processing system, including a trimming function, in each of the image processing systems in the embodiments as described above.

Further, each of the coefficients, which are used for obtaining the facial frame or setting the trimming area, may be modified according to the date of birth, the color of eyes, nationality or the like of a person, who is a photography subject.

Further, in each of the image processing systems as described above, it is assumed that the facial photograph image S0 includes a single face. However, the present invention may be applied to a case where there is a plurality of faces in a single image. For example, if there is a plurality of faces in a single image, the processing for obtaining a facial frame in the image processing system A or the image processing system B as described above may be performed for each of the plurality of faces. Then, a trimming area for trimming the plurality of faces together may be set by setting the upper and lower ends of the trimming area based on the position of the upper side of the facial frame, which is at the highest position among the upper sides of the plurality of facial frames, and the position of the lower side of the facial frame, which is at the lowest position among the lower sides of the plurality of facial frames. Alternatively, a trimming area for trimming the plurality of faces together may be set by setting the left and right ends of the trimming area based on the position of the left side of the facial frame, which is at the most left position among the left sides of the plurality of facial frames, and the position of the right side of the facial frame, which is at the most right position among the right sides of the plurality of facial frames in a similar manner.

Further, in each of the embodiments as described above, the facial frame (specifically, the left and right ends and the upper and lower ends of the facial image) is estimated by using the positions of the eyes and the distance between both eyes. Alternatively, the facial frame may be obtained by detecting the upper end (the perpendicular distance from the eyes to the top of the head) and estimating the left and right ends and the lower end (chin) of the face by using the positions of the eyes, the distance between both eyes, and the distance from the detected eyes to the top of the head. However, the ends-of-face estimation method according to each of the embodiments as described above may be partially applied to an image processing system for obtaining a facial frame by detecting the ends of the face. As a method for obtaining the ends of a face for the purpose of trimming a facial image, either “detection” or “estimation” may be performed. However, generally, if the background part of the facial photograph image is stable or the like, and image processing (detection) can be performed easily, the ends can be obtained more accurately by “detection” than “estimation”. In contrast, if the background part of the facial photograph image is complex or the like, and image processing is difficult, the ends can be obtained more accurately by “estimation” than “detection”. The degree of difficulty in image processing differs depending on whether the ears of a person are covered by his/her hair, for example. Meanwhile, if a facial image is obtained for an identification photograph, it is required to uncover the ears during photography. Therefore, in the system for obtaining the left and right ends of a face by “estimation” as in each of the embodiments as described above, if the facial photograph image, which is the processing object, is captured for the identification photograph, the left and right ends of the face may be detected by image processing instead of estimation. Further, since the degree of difficulty in image processing differs depending on whether the edge at the tip of a chin is clear. Therefore, in a photography box or the like, where lighting is provided during photography so that the line of the chin is clearly distinguished, the position of the tip of the chin (the lower end of the face) may be obtained by detection instead of estimation.

Specifically, in addition to the embodiments as described above, the facial frame estimation method according to the present invention may be partially combined with the detection method described below.

For example, the positions of eyes, the position of the top of the head, and the positions of the left and right ends of a face may be obtained by detecting. Then, the position of the tip of a chin may be estimated based on the positions of the eyes (and the distance between both eyes, which is calculated based on the positions of the eyes, hereinafter the same). Alternatively, the position of the tip of the chin may be estimated based on the positions of the eyes and the position of the top of the head (and the perpendicular distance H from the positions of the eyes to the position of the top of the head, which is calculated based on the positions of the eyes and the position of the top of the head, hereinafter the same).

Alternatively, the positions of the eyes, the position of the top of the head, and the position of the tip of the chin maybe obtained by detecting, and the positions of the left and right ends of the face may be estimated.

Alternatively, all of the positions of the left and right ends and the upper and lower ends of the face may be obtained by detecting. However, if it is judged that the accuracy in detection at any one of the positions is low, the position, which could not be detected accurately, may be obtained by estimating from the other detected positions.

Various conventional methods may be applied to the detection of the positions of the left and right ends and the upper and lower ends of the face. For example, an approximate center of the face may be defined as an origin, and an edge of a flesh color region, in the horizontal direction and the vertical direction, may be extracted. The left and right ends and the upper and lower ends of the extracted edge may be used as the ends of the face. Further, for obtaining the end point of the upper end, after an edge of the upper end is extracted, edge extraction processing may also be performed on the region of hair, and the edge of the flesh color region and the edge of the hair region may be compared. Accordingly, the position of the upper end may be obtained more accurately.

1. An image processing method comprising the steps of:
obtaining a facial frame by using each of values L1a, L1b and L1c, which are obtained by performing operations according to equations (1) by using the distance D between both eyes in a facial photograph image and coefficients U1a, U1b and U1c, as the lateral width of the facial frame with its middle in the lateral direction at the middle position Gm between both eyes in the facial photograph image, the distance from the middle position Gm to the upper side of the facial frame, and the distance from the middle position Gm to the lower side of the facial frame, respectively; and
setting a trimming area in the facial photograph image based on the position and the size of the facial frame so that the trimming area satisfies a predetermined output format, wherein the coefficients U1a, U1b and U1c are obtained by performing processing on a multiplicity of sample facial photograph images to obtain absolute values of differences between each value of Lt1a, Lt1b and Lt1c, which are obtained by performing operations according to equations (2) by using the distance Ds between both eyes in each of the sample facial photograph images and predetermined test coefficients Ut1a, Ut1b and Ut1c, the lateral width of a face, the distance from the middle position between both eyes to the upper end of the face, and the distance from the middle position between both eyes to the lower end of the face, respectively, in each of the sample facial photograph images and optimizing the test coefficients so that the sum of the absolute values of the differences, which are obtained for each of the sample facial photograph images, is minimized.
L1a=D×U1a
L1b=D×U1b (1)
L1c=D×U1c
Lt1a=Ds×Ut1a
Lt1b=Ds×Ut1b (2)
Lt1c=Ds×Ut1c

2. An image processing method comprising the steps of:
detecting the position of the top of a head from the part above the positions of eyes in a facial photograph image and calculating the perpendicular distance H from the eyes to the top of the head; obtaining a facial frame by using each of values L2a and L2c, which are obtained by performing operations according to equations (3) by using the distance D between both eyes in the facial photograph image, the perpendicular distance H and coefficients U2a and U2c, as the lateral width of the facial frame with its middle in the lateral direction at the middle position Gm between both eyes in the facial photograph image and the distance from the middle position Gm to the lower side of the facial frame, respectively, and using the perpendicular distance H as the distance from the middle position Gm to the upper side of the facial frame; and
setting a trimming area in the facial photograph image based on the position and the size of the facial frame so that the trimming area satisfies a predetermined output format, wherein the coefficients U2a and U2c are obtained by performing processing on a multiplicity of sample facial photograph images to obtain absolute values of differences between each value of Lt2a and Lt2c, which are obtained by performing operations according to equations (4) by using the perpendicular distance Hs from eyes to the top of a head and the distance Ds between both eyes in each of the sample facial photograph images and predetermined test coefficients Ut2a and Ut2c, and the lateral width of a face and the distance from the middle position between both eyes to the lower end of the face, respectively, in each of the sample facial photograph images and optimizing the test coefficients so that the sum of the absolute values of the differences, which are obtained for each of the sample facial photograph images, is minimized.
L2a=D×U2a
L2c=H×U2c (3)
Lt2a=Ds×Ut2a
Lt2b=Hs×Ut2c (4)

3. An image processing method comprising the steps of:
detecting the position of the top of a head from the part above the positions of eyes in a facial photograph image and calculating the perpendicular distance H from the eyes to the top of the head; obtaining a facial frame by using each of values L3a and L3c, which are obtained by performing operations according to equations (5) by using the distance D between both eyes in the facial photograph image, the perpendicular distance H and coefficients U3a, U3b and U3c, as the lateral width of the facial frame with its middle in the lateral direction at the middle position Gm between both eyes in the facial photograph image and the distance from the middle position Gm to the lower side of the facial frame, respectively, and using the perpendicular distance H as the distance from the middle position Gm to the upper side of the facial frame; and
setting a trimming area in the facial photograph image based on the position and the size of the facial frame so that the trimming area satisfies a predetermined output format, wherein the coefficients U3a, U3b and U3c are obtained by performing processing on a multiplicity of sample facial photograph images to obtain absolute values of differences between each value of Lt3a and Lt3c, which are obtained by performing operations according to equations (6) by using the perpendicular distance Hs from eyes to the top of a head and the distance Ds between both eyes in each of the sample facial photograph images and predetermined test coefficients Ut3a, Ut3b and Ut3c, and the lateral width of a face and the distance from the middle position between both eyes to the lower end of the face, respectively, in each of the sample facial photograph images and optimizing the test coefficients so that the sum of the absolute values of the differences, which are obtained for each of the sample facial photograph images, is minimized.
L3a=D×U3a
L3c=D×U3b+H×U3c (5)
Lt3a=Ds×Ut3a
Lt3c=Ds×Ut3b+Hs×Ut3c (6)

4. An image processing method comprising the step of:
setting a trimming area by using each of values L4a, L4b and L4c, which are obtained by performing operations according to equations (7) by using the distance D between both eyes in a facial photograph image and coefficients U4a, U4b and U4c, as the lateral width of the trimming area with its middle in the lateral direction at the middle position Gm between both eyes in the facial photograph image, the distance from the middle position Gm to the upper side of the trimming area, and the distance from the middle position Gm to the lower side of the trimming area, respectively, wherein the coefficients U4a, U4b and U4c are obtained by performing processing on a multiplicity of sample facial photograph images to obtain absolute values of differences between each value of Lt4a, Lt4b and Lt4c, which are obtained by performing operations according to equations (8) by using the distance Ds between both eyes in each of the sample facial photograph images and predetermined test coefficients Ut4a, Ut4b and Ut4c, and the lateral width of a predetermined trimming area with its middle in the lateral direction at the middle position between both eyes, the distance from the middle position between both eyes to the upper side of the predetermined trimming area and the distance from the middle position between both eyes to the lower side of the predetermined trimming area, respectively, in each of the sample facial photograph images and optimizing the test coefficients so that the sum of the absolute values of the differences, which are obtained for each of the sample facial photograph images, is minimized.
L4a=D×U4a
L4b=D×U4b (7)
L4c=D×U4c
Lt4a=Ds×Ut4a
Lt4b=Ds×Ut4b (8)
Lt4c=Ds×Ut4c

5. An image processing method comprising the steps of:
detecting the position of the top of a head from the part above the positions of eyes in a facial photograph image and calculating the perpendicular distance H from the eyes to the top of the head; and
setting a trimming area by using each of values L5a, L5b and L5c, which are obtained by performing operations according to equations (9) by using the distance D between both eyes and the perpendicular distance H in the facial photograph image and coefficients U5a, U5b and U5c, as the lateral width of the trimming area with its middle in the lateral direction at the middle position Gm between both eyes in the facial photograph image, the distance from the middle position Gm to the upper side of the trimming area, and the distance from the middle position Gm to the lower side of the trimming area, respectively, wherein the coefficients U5a, U5b and U5c are obtained by performing processing on a multiplicity of sample facial photograph images to obtain absolute values of differences between each value of Lt5a, Lt5b and Lt5c, which are obtained by performing operations according to equations (10) by using the perpendicular distance Hs from eyes to the top of a head and the distance Ds between both eyes in each of the sample facial photograph images and predetermined test coefficients Ut5a, Ut5b and Ut5c, and the lateral width of a predetermined trimming area with its middle in the lateral direction at the middle position of both eyes, the distance from the middle position between both eyes to the upper side of the trimming area and the distance from the middle position between both eyes to the lower side of the trimming area, respectively, in each of the sample facial photograph images and optimizing the test coefficients so that the sum of the absolute values of the differences, which are obtained for each of the sample facial photograph images, is minimized.
L5a=D×U5a
L5b=H×U5b (9)
L5c=H×U5c
Lt5a=Ds×Ut5a
Lt5b=Hs×Ut5b (10)
Lt5c=Hs×Ut5c

6. An image processing method comprising the steps of:
detecting the position of the top of a head from the part above the positions of eyes in a facial photograph image and calculating the perpendicular distance H from the eyes to the top of the head; and
setting a trimming area by using each of values L6a, L6b and L6c, which are obtained by performing operations according to equations (11) by using the distance D between both eyes and the perpendicular distance H in the facial photograph image and coefficients U6a, U6b1, U6c1, U6b2 and U6c2, as the lateral width of the trimming area with its middle in the lateral direction at the middle position Gm between both eyes in the facial photograph image, the distance from the middle position Gm to the upper side of the trimming area, and the distance from the middle position Gm to the lower side of the trimming area, respectively, wherein the coefficients U6a, U6bl, U6cl, U6b2 and U6c2 are obtained by performing processing on a multiplicity of sample facial photograph images to obtain absolute values of differences between each value of Lt6a, Lt6b and Lt6c, which are obtained by performing operations according to equations (12) by using the perpendicular distance Hs from eyes to the top of a head and the distance Ds between both eyes in each of the sample facial photograph images and predetermined test coefficients Ut6a, Ut6b1, Ut6c1, Ut6b2 and Ut6c2, and the lateral width of a predetermined trimming area with its middle in the lateral direction at the middle position of both eyes, the distance from the middle position between both eyes to the upper side of the trimming area and the distance from the middle position between both eyes to the lower side of the trimming area, respectively, in each of the sample facial photograph images and optimizing the test coefficients so that the sum of the absolute values of the differences, which are obtained for each of the sample facial photograph images, is minimized.
L6a=D×U6a
L6b=D×U6b1+H×U6c1 (11)
L6c=D×U6b2+H×U6c2
Lt6a=Ds×Ut6a
Lt6b=Ds×Ut6b1+Hs×Ut6c1 (12)
Lt6c=Ds×Ut6b2+Hs×Ut6c2

7. An image processing apparatus comprising:
a facial frame obtainment means for obtaining a facial frame by using each of values L1a, L1b and L1c, which are obtained by performing operations according to equations (13) by using the distance D between both eyes in a facial photograph image and coefficients U1a, U1b and U1c, as the lateral width of the facial frame with its middle in the lateral direction at the middle position Gm between both eyes in the facial photograph image, the distance from the middle position Gm to the upper side of the facial frame, and the distance from the middle position Gm to the lower side of the facial frame, respectively; and
a trimming area setting means for setting a trimming area in the facial photograph image based on the position and the size of the facial frame so that the trimming area satisfies a predetermined output format, wherein the coefficients U1a, U1b and U1c are obtained by performing processing on a multiplicity of sample facial photograph images to obtain absolute values of differences between each value of Lt1a, Lt1b and Lt1c, which are obtained by performing operations according to equations (14) by using the distance Ds between both eyes in each of the sample facial photograph images and predetermined test coefficients Ut1a, Ut1b and Ut1c, and the lateral width of a face, the distance from the middle position between both eyes to the upper end of the face, and the distance from the middle position between both eyes to the lower end of the face, respectively, in each of the sample facial photograph images and optimizing the test coefficients so that the sum of the absolute values of the differences, which are obtained for each of the sample facial photograph images, is minimized.
L1a=D×U1a
L1b=D×U1b (13)
L1c=D×U1c
Lt1a=Ds×Ut1a
Lt1b=Ds×Ut1b (14)
Lt1c=Ds×Ut1c

8. An image processing apparatus as defined in claim 7, wherein the distance between both eyes is the distance between the pupils of both eyes,
wherein the coefficients U1a, U1b and U1c are within the ranges of 3.250×(1±0.05), 1.905×(1±0.05) and 2.170×(1±0.05), respectively.

9. An image processing apparatus comprising:
a top-of-head detection means for detecting the position of the top of a head from the part above the positions of eyes in a facial photograph image and calculating the perpendicular distance H from the eyes to the top of the head;
a facial frame obtainment means for obtaining a facial frame by using each of values L2a and L2c, which are obtained by performing operations according to equations (15) by using the distance D between both eyes in the facial photograph image, the perpendicular distance H and coefficients U2a and U2c, as the lateral width of the facial frame with its middle in the lateral direction at the middle position Gm between both eyes in the facial photograph image and the distance from the middle position Gm to the lower side of the facial frame, respectively, and using the perpendicular distance H as the distance from the middle position Gm to the upper side of the facial frame; and
a trimming area setting means for setting a trimming area in the facial photograph image based on the position and the size of the facial frame so that the trimming area satisfies a predetermined output format, wherein the coefficients U2a and U2c are obtained by performing processing on a multiplicity of sample facial photograph images to obtain absolute values of differences between each value of Lt2a and Lt2c, which are obtained by performing operations according to equations (16) by using the perpendicular distance Hs from eyes to the top of a head and the distance Ds between both eyes in each of the sample facial photograph images and predetermined test coefficients Ut2a and Ut2c, and the lateral width of a face and the distance from the middle position between both eyes to the lower end of the face, respectively, in each of the sample facial photograph images and optimizing the test coefficients so that the sum of the absolute values of the differences, which are obtained for each of the sample facial photograph images, is minimized.
L2a=D×U2a
L2c=H×U2c (15)
Lt2a=Ds×Ut2a
Lt2c=Hs×Ut2c (16)

10. An image processing apparatus as defined in claim 9, wherein the distance between both eyes is the distance between the pupils of both eyes,
wherein the coefficients U2a and U2c are within the ranges of 3.250×(1±0.05) and 0.900×(1±0.05), respectively.

11. An image processing apparatus comprising:
a top-of-head detection means for detecting the position of the top of a head from the part above the positions of eyes in a facial photograph image and calculating the perpendicular distance H from the eyes to the top of the head;
a facial frame obtainment means for obtaining a facial frame by using each of values L3a and L3c, which are obtained by performing operations according to equations (17) by using the distance D between both eyes in the facial photograph image, the perpendicular distance H and coefficients U3a, U3b and U3c, as the lateral width of the facial frame with its middle in the lateral direction at the middle position Gm between both eyes in the facial photograph image and the distance from the middle position Gm to the lower side of the facial frame, respectively, and using the perpendicular distance H as the distance from the middle position Gm to the upper side of the facial frame; and
a trimming area setting means for setting a trimming area in the facial photograph image based on the position and the size of the facial frame so that the trimming area satisfies a predetermined output format, wherein the coefficients U3a, U3b and U3c are obtained by performing processing on a multiplicity of sample facial photograph images to obtain absolute values of differences between each value of Lt3a and Lt3c, which are obtained by performing operations according to equations (18) by using the perpendicular distance Hs from eyes to the top of a head and the distance Ds between both eyes in each of the sample facial photograph images and predetermined test coefficients Ut3a, Ut3b and Ut3c, and the lateral width of a face and the distance from the middle position between both eyes to the lower end of the face, respectively, in each of the sample facial photograph images and optimizing the test coefficients so that the sum of the absolute values of the differences, which are obtained for each of the sample facial photograph images, is minimized.
L3a=D×U3a
L3c=D×U3b+H×U3c (17)
Lt3a=Ds×Ut3a
Lt3b=Ds×Ut3b+Hs×Ut3c (18)

12. An image processing apparatus as defined in claim 11, wherein the distance between both eyes is the distance between the pupils of both eyes,
wherein the coefficients U3a, U3b and U3c are within the ranges of 3.250×(1±0.05), 1.525×(1±0.05) and 0.187×(1±0.05), respectively.

13. An image processing apparatus comprising:
a trimming area setting means for setting a trimming area by using each of values L4a, L4b and L4c, which are obtained by performing operations according to equations (19) by using the distance D between both eyes in a facial photograph image and coefficients U4a, U4b and U4c, as the lateral width of the trimming area with its middle in the lateral direction at the middle position Gm between both eyes in the facial photograph image, the distance from the middle position Gm to the upper side of the trimming area, and the distance from the middle position Gm to the lower side of the trimming area, respectively, wherein the coefficients U4a, U4b and U4c are obtained by performing processing on a multiplicity of sample facial photograph images to obtain absolute values of differences between each value of Lt4a, Lt4b and Lt4c, which are obtained by performing operations according to equations (20) by using the distance Ds between both eyes in each of the sample facial photograph images and predetermined test coefficients Ut4a, Ut4b and Ut4c, and the lateral width of a predetermined trimming area with its middle in the lateral direction at the middle position between both eyes, the distance from the middle position between both eyes to the upper side of the predetermined trimming area and the distance from the middle position between both eyes to the lower side of the predetermined trimming area, respectively, in each of the sample facial photograph images and optimizing the test coefficients so that the sum of the absolute values of the differences, which are obtained for each of the sample facial photograph images, is minimized.
L4a=D×U4a
L4b=D×U4b (19)
L4c=D×U4c
Lt4a=Ds×Ut4a
Lt4b=Ds×Ut4b (20)
Lt4c=Ds×Ut4c

14. An image processing apparatus as defined in claim 13, wherein the distance between both eyes is the distance between the pupils of both eyes,
wherein the coefficients U4a, U4b and U4c are within the ranges of (5.04×range coefficient), (3.01×range coefficient) and (3.47×range coefficient), respectively, and wherein the range coefficient is (1±0.4).

15. An image processing apparatus comprising:
a top-of-head detection means for detecting the position of the top of a head from the part above the positions of eyes in a facial photograph image and calculating the perpendicular distance H from the eyes to the top of the head; and
a trimming area setting means for setting a trimming area by using each of values L5a, L5b and L5c, which are obtained by performing operations according to equations (21) by using the distance D between both eyes and the perpendicular distance H in the facial photograph image and coefficients U5a, U5b and U5c, as the lateral width of the trimming area with its middle in the lateral direction at the middle position Gm between both eyes in the facial photograph image, the distance from the middle position Gm to the upper side of the trimming area, and the distance from the middle position Gm to the lower side of the trimming area, respectively, wherein the coefficients U5a, U5b and U5c are obtained by performing processing on a multiplicity of sample facial photograph images to obtain absolute values of differences between each value of Lt5a, Lt5b and Lt5c, which are obtained by performing operations according to equations (22) by using the perpendicular distance Hs from eyes to the top of a head and the distance Ds between both eyes in each of the sample facial photograph images and predetermined test coefficients Ut5a, Ut5b and Ut5c, and the lateral width of a predetermined trimming area with its middle in the lateral direction at the middle position of both eyes, the distance from the middle position between both eyes to the upper side of the trimming area and the distance from the middle position between both eyes to the lower side of the trimming area, respectively, in each of the sample facial photograph images and optimizing the test coefficients so that the sum of the absolute values of the differences, which are obtained for each of the sample facial photograph images, is minimized.
L5a=D×U5a
L5b=H×U5b (21)
L5c=H×U5c
Lt5a=Ds×Ut5a
Lt5b=Hs×Ut5b (22)
Lt5c=Hs×Ut5c

16. An image processing apparatus as defined in claim 15, wherein the distance between both eyes is the distance between the pupils of both eyes,
wherein the coefficients U5a, U5b and U5c are within the ranges of (5.04×range coefficient), (1.495×range coefficient) and (1.89×range coefficient), respectively, and wherein the range coefficient is (1±0.4).

17. An image processing apparatus comprising:
a top-of-head detection means for detecting the position of the top of a head from the part above the positions of eyes in a facial photograph image and calculating the perpendicular distance H from the eyes to the top of the head; and
a trimming area setting means for setting a trimming area by using each of values L6a, L6b and L6c, which are obtained by performing operations according to equations (23) by using the distance D between both eyes and the perpendicular distance H in the facial photograph image and coefficients U6a, U6b1, U6c1, U6b2 and U6c2, as the lateral width of the trimming area with its middle in the lateral direction at the middle position Gm between both eyes in the facial photograph image, the distance from the middle position Gm to the upper side of the trimming area, and the distance from the middle position Gm to the lower side of the trimming area, respectively, wherein the coefficients U6a, U6b1, U6c1, U6b2 and U6c2 are obtained by performing processing on a multiplicity of sample facial photograph images to obtain absolute values of differences between each value of Lt6a, Lt6b and Lt6c, which are obtained by performing operations according to equations (24) by using the perpendicular distance Hs from eyes to the top of a head and the distance Ds between both eyes in each of the sample facial photograph images and predetermined test coefficients Ut6a, Ut6b1, Ut6c1, Ut6b2 and Ut6c2, and the lateral width of a predetermined trimming area with its middle in the lateral direction at the middle position of both eyes, the distance from the middle position between both eyes to the upper side of the trimming area and the distance from the middle position between both eyes to the lower side of the trimming area, respectively, in each of the sample facial photograph images and optimizing the test coefficients so that the sum of the absolute values of the differences, which are obtained for each of the sample facial photograph images, is minimized.
L6a=D×U6a
L6b=D×U6b1+H×U6c (23)
L6c=D×U6b2+H×U6c2
Lt6a=Ds×Ut6a
Lt6b=Ds×Ut6b1+Hs×Ut6c1 (24)
Lt6c=Ds×Ut6b2+Hs×Ut6c2

18. An image processing apparatus as defined in claim 17, wherein the distance between both eyes is the distance between the pupils of both eyes,
wherein the coefficients U6a, U6bl, U6c1, U6b2 and U6c2 are within the ranges of (5.04×range coefficient), (2.674×range coefficient), (0.4074×range coefficient), (0.4926×range coefficient) and (1.259×range coefficient), respectively, and wherein the range coefficient is (1±0.4).

19. An image processing apparatus as defined in any one of claims 14, 16 and 18, wherein the range coefficient is (1±0.25).

20. An image processing apparatus as defined in claim 19, wherein the range coefficient is (1±0.10).

21. An image processing apparatus as defined in claim 20, wherein the range coefficient is (1±0.05).

22. A program for causing a computer to execute a processing method, the program comprising the procedures for:
obtaining a facial frame by using each of values L1a, L1b and L1c, which are obtained by performing operations according to equations (25) by using the distance D between both eyes in a facial photograph image and coefficients U1a, U1b and U1c, as the lateral width of the facial frame with its middle in the lateral direction at the middle position Gm between both eyes in the facial photograph image, the distance from the middle position Gm to the upper side of the facial frame, and the distance from the middle position Gm to the lower side of the facial frame, respectively; and
setting a trimming area in the facial photograph image based on the position and the size of the facial frame so that the trimming area satisfies a predetermined output format, wherein the coefficients U1a, U1b and U1c are obtained by performing processing on a multiplicity of sample facial photograph images to obtain absolute values of differences between each value of Lt1a, Lt1b and Lt1c, which are obtained by performing operations according to equations (26) by using the distance Ds between both eyes in each of the sample facial photograph images and predetermined test coefficients Ut1a, Ut1b and Ut1c, and the lateral width of a face, the distance from the middle position between both eyes to the upper end of the face, and the distance from the middle position between both eyes to the lower end of the face, respectively, in each of the sample facial photograph images and optimizing the test coefficients so that the sum of the absolute values of the differences, which are obtained for each of the sample facial photograph images, is minimized.
L1a=D×U1a
L1b=D×U1b (25)
L1c=D×U1c
Lt1a=Ds×Ut1a
Lt1b=Ds×Ut1b (26)
Lt1c=Ds×Ut1c

23. A program for causing a computer to execute a processing method, the program comprising the procedures for:
detecting the position of the top of a head from the part above the positions of eyes in a facial photograph image and calculating the perpendicular distance H from the eyes to the top of the head; obtaining a facial frame by using each of values L2a and L2c, which are obtained by performing operations according to equations (27) by using the distance D between both eyes in the facial photograph image, the perpendicular distance H and coefficients U2a and U2c, as the lateral width of a facial frame with its middle in the lateral direction at the middle position Gm between both eyes in the facial photograph image and the distance from the middle position Gm to the lower side of the facial frame, respectively, and using the perpendicular distance H as the distance from the middle position Gm to the upper side of the facial frame; and
setting a trimming area in the facial photograph image based on the position and the size of the facial frame so that the trimming area satisfies a predetermined output format, wherein the coefficients U2a and U2c are obtained by performing processing on a multiplicity of sample facial photograph images to obtain absolute values of differences between each value of Lt2a and Lt2c, which are obtained by performing operations according to equations (28) by using the perpendicular distance Hs from eyes to the top of a head and the distance Ds between both eyes in each of the sample facial photograph images and predetermined test coefficients Ut2a and Ut2c, and the lateral width of a face and the distance from the middle position between both eyes to the lower end of the face, respectively, in each of the sample facial photograph images and optimizing the test coefficients so that the sum of the absolute values of the differences, which are obtained for each of the sample facial photograph images, is minimized.
L2a=D×U2a
L2c=H×U2c (27)
Lt2a=Ds×Ut2a
Lt2c=Hs×Ut2c (28)

24. A program for causing a computer to execute a processing method, the program comprising the procedures for:
detecting the position of the top of a head from the part above the positions of eyes in a facial photograph image and calculating the perpendicular distance H from the eyes to the top of the head; obtaining a facial frame by using each of values L3a and L3c, which are obtained by performing operations according to equations (29) by using the distance D between both eyes in the facial photograph image, the perpendicular distance H and coefficients U3a, U3b and U3c, as the lateral width of the facial frame with its middle in the lateral direction at the middle position Gm between both eyes in the facial photograph image and the distance from the middle position Gm to the lower side of the facial frame, respectively, and using the perpendicular distance H as the distance from the middle position Gm to the upper side of the facial frame; and
setting a trimming area in the facial photograph image based on the position and the size of the facial frame so that the trimming area satisfies a predetermined output format, wherein the coefficients U3a, U3b and U3c are obtained by performing processing on a multiplicity of sample facial photograph images to obtain absolute values of differences between each value of Lt3a and Lt3c, which are obtained by performing operations according to equations (30) by using the perpendicular distance Hs from eyes to the top of a head and the distance Ds between both eyes in each of the sample facial photograph images and predetermined test coefficients Ut3a, Ut3b and Ut3c, and the lateral width of a face and the distance from the middle position between both eyes to the lower end of the face, respectively, in each of the sample facial photograph images and optimizing the test coefficients so that the sum of the absolute values of the differences, which are obtained for each of the sample facial photograph images, is minimized.
L3a=D×U3a
L3c=D×U3b+H×U3c (29)
Lt3a=Ds×Ut3a
Lt3b=Ds×Ut3b+Hs×Ut3c (30)

25. A program for causing a computer to execute a processing method, the program comprising the procedures for:
setting a trimming area by using each of values L4a, L4b and L4c, which are obtained by performing operations according to equations (31) by using the distance D between both eyes in a facial photograph image and coefficients U4a, U4b and U4c, as the lateral width of the trimming area with its middle in the lateral direction at the middle position Gm between both eyes in the facial photograph image, the distance from the middle position Gm to the upper side of the trimming area, and the distance from the middle position Gm to the lower side of the trimming area, respectively, wherein the coefficients U4a, U4b and U4c are obtained by performing processing on a multiplicity of sample facial photograph images to obtain absolute values of differences between each value of Lt4a, Lt4b and Lt4c, which are obtained by performing operations according to equations (32) by using the distance Ds between both eyes in each of the sample facial photograph images and predetermined test coefficients Ut4a, Ut4b and Ut4c, and the lateral width of a predetermined trimming area with its middle in the lateral direction at the middle position between both eyes, the distance from the middle position between both eyes to the upper side of the predetermined trimming area and the distance from the middle position between both eyes to the lower side of the predetermined trimming area, respectively, in each of the sample facial photograph images and optimizing the test coefficients so that the sum of the absolute values of the differences, which are obtained for each of the sample facial photograph images, is minimized.
L4a=D×U4a
L4b=D×U4b (31)
L4c=D×U4c
Lt4a=Ds×Ut4a
Lt4b=Ds×Ut4b (32)
Lt4c=Ds×Ut4c

26. A program for causing a computer to execute a processing method, the program comprising the procedures for:
detecting the position of the top of a head from the part above the positions of eyes in a facial photograph image and calculating the perpendicular distance H from the eyes to the top of the head; and
setting a trimming area by using each of values L5a, L5b and L5c, which are obtained by performing operations according to equations (33) by using the distance D between both eyes and the perpendicular distance H in the facial photograph image and coefficients U5a, U5b and U5c, as the lateral width of the trimming area with its middle in the lateral direction at the middle position Gm between both eyes in the facial photograph image, the distance from the middle position Gm to the upper side of the trimming area, and the distance from the middle position Gm to the lower side of the trimming area, respectively, wherein the coefficients U5a, U5b and U5c are obtained by performing processing on a multiplicity of sample facial photograph images to obtain absolute values of differences between each value of Lt5a, Lt5b and Lt5c, which are obtained by performing operations according to equations (34) by using the perpendicular distance Hs from eyes to the top of a head and the distance Ds between both eyes in each of the sample facial photograph images and predetermined test coefficients Ut5a, Ut5b and Ut5c, and the lateral width of a predetermined trimming area with its middle in the lateral direction at the middle position of both eyes, the distance from the middle position between both eyes to the upper side of the trimming area and the distance from the middle position between both eyes to the lower side of the trimming area, respectively, in each of the sample facial photograph images and optimizing the test coefficients so that the sum of the absolute values of the differences, which are obtained for each of the sample facial photograph images, is minimized.
L5a=D×U5a
L5b=H×U5b (33)
L5c=H×U5c
Lt5a=Ds×Ut5a
Lt5b=Hs×Ut5b (34)
Lt5c=Hs×Ut5c

27. A program for causing a computer to execute a processing method, the program comprising the procedures for:
detecting the position of the top of a head from the part above the positions of eyes in a facial photograph image and calculating the perpendicular distance H from the eyes to the top of the head; and
setting a trimming area by using each of values L6a, L6b and L6c, which are obtained by performing operations according to equations (35) by using the distance D between both eyes and the perpendicular distance H in the facial photograph image and coefficients U6a, U6b1, U6c1, U6b2 and U6c2, as the lateral width of the trimming area with its middle in the lateral direction at the middle position Gm between both eyes in the facial photograph image, the distance from the middle position Gm to the upper side of the trimming area, and the distance from the middle position Gm to the lower side of the trimming area, respectively, wherein the coefficients U6a, U6b1, U6c1, U6b2 and U6c2 are obtained by performing processing on a multiplicity of sample facial photograph images to obtain absolute values of differences between each value of Lt6a, Lt6b and Lt6c, which are obtained by performing operations according to equations (36) by using the perpendicular distance Hs from eyes to the top of a head and the distance Ds between both eyes in each of the sample facial photograph images and predetermined test coefficients Ut6a, Ut6b1, Ut6c1, Ut6b2 and Ut6c2, and the lateral width of a predetermined trimming area with its middle in the lateral direction at the middle position of both eyes, the distance from the middle position between both eyes to the upper side of the trimming area and the distance from the middle position between both eyes to the lower side of the trimming area, respectively, in each of the sample facial photograph images and optimizing the test coefficients so that the sum of the absolute values of the differences, which are obtained for each of the sample facial photograph images, is minimized.
L6a=D×U6a
L6b=D×U6b1+H×U6c1 (35)
L6c=D×U6b2+H×U6c2
Lt6a=Ds×Ut6a
Lt6b=Ds×Ut6b1+Hs×Ut6c (36)
Lt6c=Ds×Ut6b2+Hs×Ut6c2

28. A digital camera comprising:
a photographing means;
a trimming area obtainment means for obtaining a trimming area in a facial photograph image, which is obtained by the photographing means; and
a trimming performing means for obtaining a trimming image by performing trimming on the facial photograph image based on the trimming area, which is obtained by the trimming area obtainment means, wherein the trimming area obtainment means is the image processing apparatus as defined in any one of claims 7, 8, 9, 10, 11, 12, 13, 15 and 17.

29. A photography box apparatus comprising:
a photographing means;
a trimming area obtainment means for obtaining a trimming area in a facial photograph image, which is obtained by the photographing means; and
a trimming performing means for obtaining a trimming image by performing trimming on the facial photograph image based on the trimming area, which is obtained by the trimming area obtainment means, wherein the trimming area obtainment means is the image processing apparatus as defined in any one of claims 7, 8, 9, 10, 11, 12, 13, 15 and 17.
